(19) United States
(12) Patent Application Publication
(10) Pub. No.: US 2026/0292641 A1
(43) Pub. Date: Sep. 24, 2026

(54) INTELLIGENT DATA REPORTING FOR AI/ML OFFLOADING ACTIONS IN RAN

(71) Applicant: TELEFONAKTIEBOLAGET LM ERICSSON (PUBL), Stockholm (SE)

(72) Inventors: Germán Bassi, Årsta (SE); Philipp Bruhn, Aachen (DE); Reem Karaki, Aachen (DE); Luca Lunardi, Genova (IT); Ioanna Pappa, Stockholm (SE); Angelo Centonza, Granada (ES)

(21) Appl. No.: 19/472,964

(22) PCT Filed: Apr. 3, 2024
(86) PCT No.: PCT/EP2024/059099

§ 371 Date: Oct. 6, 2025

(30) Foreign Application Priority Data
Apr. 6, 2023 (GR) 20230100295

(51) Int. Cl. H04W 36/30

(52) U.S. Cl. CPC H04W 36/304

(57) ABSTRACT

Systems and methods are disclosed for reporting data related to User Equipment (UE) mobility and offloading (UMO) actions in a cellular communications system. In one embodiment, a method performed by a second network node comprises receiving, from either a first network node or a fourth network node, a first message(s) comprising a request(s) for reporting a prediction(s) and/or measurement(s) of a certain metric(s) in relation to a UMO action(s) that involve at least the second network node. The method further comprises transmitting, to either the first network node or the fourth network node, a second message comprising the prediction(s) in a disaggregated manner such that the prediction(s) reflect separate contributions of the UMO action(s) and/or transmitting, to either the first network node or the fourth network node, a third message comprising the measurement(s) in a disaggregated manner such that the measurement(s) reflect separate contributions of the UMO action(s).

### RELATED APPLICATIONS

This application claims the benefit of Greek patent application No. 20230100295, filed Apr. 6, 2023, the disclosure of which is hereby incorporated herein by reference in its entirety.

### TECHNICAL FIELD

The present disclosure relates to reporting of data related to User Equipment (UE) Mobility and Offloading (UMO) actions in a cellular communications system.

### BACKGROUND

### 5G RAN Architecture

The current 3^{rd} Generation Partnership Project (3GPP) 5th Generation (5G) Radio Access Network (RAN), or Next Generation RAN (NG-RAN), architecture is depicted in FIG. 1 and described in 3GPP Technical Specification (TS) 38.401 v17.2.0 as follows.

The NG-RAN consists of a set of gNodeBs (gNBs) connected to the 5G Core (5GC) through the Next Generation (NG) interface. As specified in 3GPP TS 38.300, the NG-RAN could also consist of a set of next generation eNodeBs (ng-eNBs), where an ng-eNB may consist of an ng-eNB-Central Unit (CU) and one or more ng-eNB-Distributed Units (DUs). An ng-eNB-CU and an ng-eNB-DU are connected via W1 interface. The general principle described here also applies to ng-eNB and W1 interface, if not explicitly specified otherwise. An gNB can support Frequency Division Duplexing (FDD) mode, Time Division Duplexing (TDD) mode, or dual mode operation. gNBs can be interconnected through the Xn interface.

A gNB may consist of a gNB-CU and one or more gNB-DU(s). A gNB-CU and a gNB-DU is connected via F1 interface. One gNB-DU is connected to only one gNB-CU.

NG, Xn, and F1 are logical interfaces.

For NG-RAN, the NG and Xn-C interfaces for a gNB consisting of a gNB-CU and gNB-DUs, terminate in the gNB-CU. For Evolved Universal Terrestrial Access (EUTRA) and NR Dual Connectivity (EN-DC), the S1-U and X2-C interfaces for a gNB consisting of a gNB-CU and gNB-DUs, terminate in the gNB-CU. The gNB-CU and connected gNB-DUs are only visible to other gNBs and the 5GC as a gNB.

The overall architecture for separation of gNB-CU-Control Plane (CP) and gNB-CU-User Plane (UP) is depicted in FIG. 2. A gNB may consist of a gNB-CU-CP, multiple gNB-CU-UPs, and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP.

It needs to be mentioned that the architecture shown above is what 3GPP has defined for 5G. Other standardization groups, such as the Open RAN (O-RAN) Alliance, have further extended the architecture above and have for example split the gNB-DU into two further nodes connected by a fronthaul interface. The lower node of the split gNB-DU would contain the PHY protocol and the Radio Frequency (RF) parts, the upper node of the split gNB-DU would host the Radio Link Control (RLC) and Medium Access Control (MAC). In O-RAN, the upper node is called O-DU, while the lower node is called O-Radio Unit (RU).

### Current 3GPP Discussions on AI/ML for NG-RAN

The 3GPP RAN3 Study Item (SI) “Study on enhancement for data collection for NR and EN-DC” studied general high-level principles, a functional framework, and potential use cases for Artificial Intelligence (AI)-enabled RAN. The accomplishments of the study are documented in 3GPP Technical Report (TR) 37.817 v17.0.0. The normative work based on the conclusion of the Release 17 SI is currently undertaken in Release 18; the related Work Item (WI) “Artificial Intelligence (AI)/Machine Learning (ML) for NG-RAN” is described in RP-213602. The main objective of the WI is:
Specify data collection enhancements and signaling support within existing NG-RAN interfaces and architecture (including non-split architecture and split architecture) for AI/ML-based Network Energy Saving, Load Balancing and Mobility Optimization.

In the RAN3 #119 meeting, the following agreements related to the AI/ML-based Network Energy Saving use case were noted:
Introduce the metric of Energy Cost (EC) as the AI/ML metric to be shared over the Xn interface among gNBs.
Adopt the below Option-3a and exchange Energy Cost (EC) upon request over the Xn interface.
The metric of Energy Cost (EC) exchanged between NG-RAN nodes can be an inferred energy consumption related to an additional load or an actual energy consumption value from a neighboring node for either additional load or current load (The details to be further discussed). EC is a value at gNB level.

As the last agreement notes, the Energy Cost (EC) value transmitted from the neighboring NG-RAN node is a measure of the energy consumption, which is either related to an additional load, both in the case of an inferred (predicted) EC or an actual measurement of EC, or which is related to the actual (measured) EC of the current load. In this agreement, the term “additional load” refers to an offloading action where a certain number of UEs served by the local NG-RAN node are handed over to the neighboring NG-RAN node so they can be served there. An inferred EC related to an additional load is simply a predicted EC assuming the offloading action will happen, i.e., the certain number of UEs will be transferred from the first NG-RAN node to the neighboring NG-RAN node.

The objective of the exchange of EC values is to allow an NG-RAN node to assess the energy impact of proposed actions, e.g., offloading UEs, in all affected RAN nodes and not just locally, both as an estimate before taking an action and as a measurement after the action is complete. In this way, AI/ML algorithms can be trained and employed such that the overall energy consumption of the network can be decreased.

RAN3 has already agreed to introduce a new class 1 procedure for subscribing to AI/ML-related assistance information, which comprises the messages provisionally named AI/ML INFORMATION REQUEST, RESPONSE, and FAILURE, and a class 2 procedure for reporting the said AI/ML-related assistance information, using the provisionally named AI/ML INFORMATION UPDATE message. There are ongoing discussions to introduce a new class 1 procedure for the case that AI/ML-related assistance information is needed in relation to a proposed action, like the offloading action describe above, which is composed of the messages provisionally named AI/ML ACTION EVALUATION REQUEST, RESPONSE, and FAILURE.

### Impact of an Offloading Action

The impact that an offloading action has on a certain network node depends on the current and future state of that network node. Each network node knows its past and present traffic and can predict its future traffic better than other network nodes, hence the agreement in RAN3.

For the case of a traffic load that is constant in time, it is known that the energy consumption of a network node is close to linear with the load. However, if the network node has some sleep mode capabilities, the energy consumption can be decreased by condensing the data into bursts; the average load over time does not change but the network node can save energy during the times in-between bursts. Note that one such network energy saving technique is referred to as Cell Discontinuous Transmit (DTX)/Discontinuous Receive (DRX), which was discussed during the Release 18 “Study on network energy savings for NR” (cf. 3GPP TR 38.864 v18.0.0) and is currently being standardized in 3GPP. As a result of this, even if a network node knows the amount of traffic being transferred to a neighboring network node, it might not be able to accurately predict the energy consumption the neighboring network node would experience.

The previous problem is compounded by the fact that, even if a network node knows the amount of traffic being transferred to a neighboring network node, the network node might not be able to accurately predict the additional load (or resource utilization) the traffic will cause in the neighboring network node. Users who had good radio conditions at the network node and could meet their traffic with short packet bursts might need longer transmissions at the neighboring network node if the radio conditions are not so favorable, or vice versa. This issue, in addition to different capabilities of the network nodes, results in different loads for the same traffic, e.g., in terms of data volume.

### SUMMARY

Systems and methods are disclosed for reporting data related to User Equipment (UE) mobility and offloading (UMO) actions in a cellular communications system. In one embodiment, a method performed by a second network node comprises receiving one or more first messages from either a first network node or a fourth network node, wherein the one or more first messages comprise one or more requests for reporting either or both of: (a) one or more predictions of one or more certain metrics in relation to one or more UMO actions that involve at least the second network node (and, e.g., the first network node and/or a third network node(s)) and (b) one or more measurements of the one or more certain metrics in relation to the one or more UMO actions that involve at least the second network node (and, e.g., the first network node and/or a third network node(s)). The method further comprises either or both of: (i) transmitting a second message to either the first network node or the fourth network node, wherein the second message comprises the one or more predictions of the one or more certain metrics in a disaggregated manner such that, the one or more predictions of the one or more certain metrics reflect separate contributions of the one or more UMO actions, and (ii) transmitting a third message to either the first network node or the fourth network node, wherein the third message comprises the one or more measurements of the one or more certain metrics in a disaggregated manner such that, the one or more measurements of the one or more certain metrics reflect separate contributions of the one or more UMO actions. In this manner, a network node to request and receive, from another network node, in the context of at least one executed or planned UMO action towards the other network node, more detailed information on measurements and/or predictions of certain metrics at the other network node.

Corresponding embodiments of a second network node are also disclosed. In one embodiment, a second network node is adapted to receive one or more first messages from either a first network node or a fourth network node, wherein the one or more first messages comprise one or more requests for reporting either or both of: (a) one or more predictions of one or more certain metrics in relation to one or more UMO actions that involve at least the second network node (and, e.g., the first network node and/or a third network node(s)) and (b) one or more measurements of the one or more certain metrics in relation to the one or more UMO actions that involve at least the second network node (and, e.g., the first network node and/or a third network node(s)). The second network node is further adapted to either or both: (i) transmit a second message to either the first network node or the fourth network node, wherein the second message comprises the one or more predictions of the one or more certain metrics in a disaggregated manner such that, the one or more predictions of the one or more certain metrics reflect separate contributions of the one or more UMO actions, and (ii) transmit a third message to either the first network node or the fourth network node, wherein the third message comprises the one or more measurements of the one or more certain metrics in a disaggregated manner such that, the one or more measurements of the one or more certain metrics reflect separate contributions of the one or more UMO actions.

Embodiments of a method performed by a first network node are also disclosed. In one embodiment, a method performed by a first network node comprises sending one or more first messages to a second network node, wherein the one or more first messages comprises one or more requests for reporting either or both of: (a) one or more predictions of one or more certain metrics in relation to one or more UMO actions that involve at least the second network node (and, e.g., the first network node and/or a third network node(s)) and (b) one or more measurements of the one or more certain metrics in relation to the one or more UMO actions that involve at least the second network node (and, e.g., the first network node and/or a third network node(s)). The method further comprises either or both of: (i) receiving a second message from the second network node, wherein the second message comprises the one or more predictions of the one or more certain metrics in a disaggregated manner such that, the one or more predictions of the one or more certain metrics reflect separate contributions of the one or more UMO actions, and (ii) receiving a third message from the second network node, wherein the third message comprises the one or more measurements of the one or more certain metrics in a disaggregated manner such that, the one or more measurements of the one or more certain metrics reflect separate contributions of the one or more UMO actions.

Corresponding embodiments of a first network node are also disclosed. In one embodiment, a first network node is adapted to send one or more first messages to a second network node, wherein the one or more first messages comprises one or more requests for reporting either or both of: (a) one or more predictions of one or more certain metrics in relation to one or more UMO actions that involve at least the second network node (and, e.g., the first network node and/or a third network node(s)) and (b) one or more measurements of the one or more certain metrics in relation to the one or more UMO actions that involve at least the second network node (and, e.g., the first network node and/or a third network node(s)). The first network node is further adapted to either or both: (i) receive a second message from the second network node, wherein the second message comprises the one or more predictions of the one or more certain metrics in a disaggregated manner such that, the one or more predictions of the one or more certain metrics reflect separate contributions of the one or more UMO actions, and (ii) receive a third message from the second network node, wherein the third message comprises the one or more measurements of the one or more certain metrics in a disaggregated manner such that, the one or more measurements of the one or more certain metrics reflect separate contributions of the one or more UMO actions.

Embodiments of a method performed by a fourth network node are also disclosed. In In one embodiment, a method performed by a fourth network node comprises sending one or more first messages to a second network node, wherein the one or more first messages comprises one or more requests for reporting either or both of: (a) one or more predictions of one or more certain metrics in relation to one or more UMO actions that involve at least the second network node (and, e.g., the first network node and/or a third network node(s)) and (b) one or more measurements of the one or more certain metrics in relation to the one or more UMO actions that involve at least the second network node (and, e.g., the first network node and/or a third network node(s)). The method further comprises either or both of: (i) receiving a second message from the second network node, wherein the second message comprises the one or more predictions of the one or more certain metrics in a disaggregated manner such that, the one or more predictions of the one or more certain metrics reflect separate contributions of the one or more UMO actions, and (ii) receiving a third message from the second network node, wherein the third message comprises the one or more measurements of the one or more certain metrics in a disaggregated manner such that, the one or more measurements of the one or more certain metrics reflect separate contributions of the one or more UMO actions.

Corresponding embodiments of a fourth network node are also disclosed. In one embodiment, a fourth network node is adapted to send one or more first messages to a second network node, wherein the one or more first messages comprises one or more requests for reporting either or both of: (a) one or more predictions of one or more certain metrics in relation to one or more UMO actions that involve at least the second network node (and, e.g., the first network node and/or a third network node(s)) and (b) one or more measurements of the one or more certain metrics in relation to the one or more UMO actions that involve at least the second network node (and, e.g., the first network node and/or a third network node(s)). The fourth network node is further adapted to either or both: (i) receive a second message from the second network node, wherein the second message comprises the one or more predictions of the one or more certain metrics in a disaggregated manner such that, the one or more predictions of the one or more certain metrics reflect separate contributions of the one or more UMO actions, and (ii) receive a third message from the second network node, wherein the third message comprises the one or more measurements of the one or more certain metrics in a disaggregated manner such that, the one or more measurements of the one or more certain metrics reflect separate contributions of the one or more UMO actions.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the current 3^{rd} Generation Partnership Project (3GPP) 5th Generation (5G) Radio Access Network (RAN), or Next Generation RAN (NG-RAN), architecture;

FIG. 2 illustrates the overall architecture for separation of gNodeB (gNB)-Central Unit (CU)-Control Plane (CP) and gNB-CU-User Plane (UP);

FIGS. 3, 4, 5, 6, and 7 illustrate example embodiments of a procedure for reporting data related to User Equipment (UE) mobility and offloading (UMO) actions, in accordance with the present disclosure;

FIG. 8 shows an example of a communication system in accordance with some embodiments of the present disclosure;

FIG. 9 shows a User Equipment device (UE) in accordance with some embodiments of the present disclosure;

FIG. 10 shows a network node in accordance with some embodiments of the present disclosure;

FIG. 11 is a block diagram of a host, which may be an embodiment of the host of FIG. 8, in accordance with various aspects of the present disclosure described herein;

FIG. 12 is a block diagram illustrating a virtualization environment in which functions implemented by some embodiments of the present disclosure may be virtualized; and

FIG. 13 shows a communication diagram of a host communicating via a network node with a UE over a partially wireless connection in accordance with some embodiments of the present disclosure.

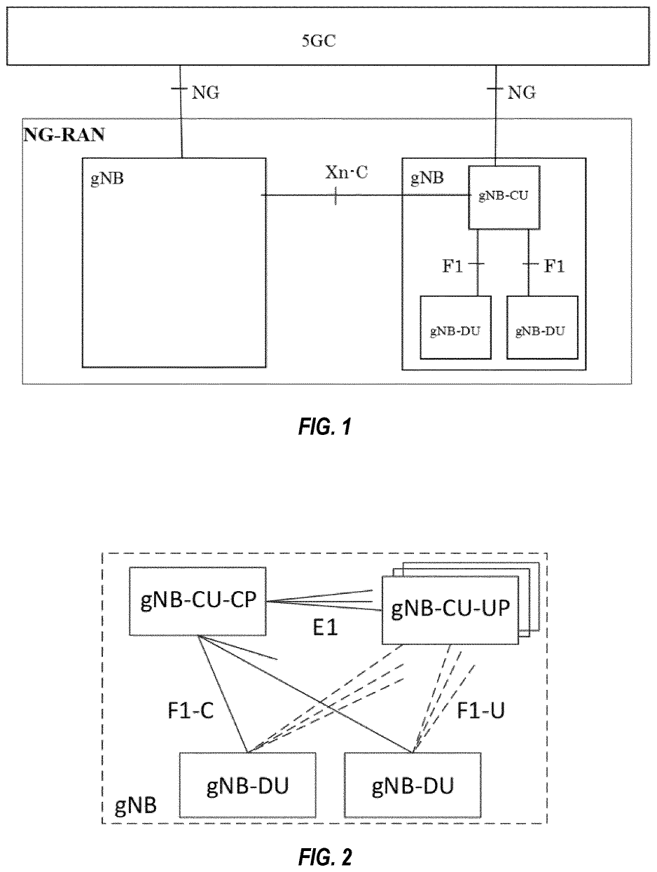

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Embodiments are provided by way of example to convey the scope of the subject matter to those skilled in the art.

For the purpose of the present disclosure, a network node can be a Radio Access Network (RAN) node, a Core Network node, an Operations, Administration, and Maintenance (OAM) node, a Service Management and Orchestration (SMO) node, a Network Management System (NMS), a Non-Real-Time RAN Intelligent Controller (Non-RT RIC), a near-Real-Time RAN Intelligent Controller (near-RT RIC), a gNodeB (gNB), evolved NodeB (eNB), en-gNB, next generation eNB (ng-eNB), gNB-Central Unit (CU), gNB-Distributed Unit (DU), gNB-CU-Control Plane (CP), gNB-CU-UP, eNB-CU, eNB-DU, eNB-CU-CP, eNB-CU-UP, Integrated Access and Backhual (IAB)-node, IAB-donor DU, IAB-donor-CU, IAB-DU, IAB-Mobile Termination (MT), Open RAN (O)-CU, O-CU-CP, O-CU-UP, O-DU, O-RU, O-eNB, a Cloud-based network function, a Cloud-based centralized training node.

The terms “disaggregation levels”, “disaggregation reporting levels”, “disaggregation reporting”, “disaggregation granularity”, “granularity levels”, “reporting disaggregation levels”, “reporting granularity”, “reporting granularity levels”, “reporting levels”, or similar can be used interchangeably.

There currently exist certain challenge(s). According to the agreements mentioned in the BACKGROUND section, a first Next Generation RAN (NG-RAN) node could obtain from a neighboring NG-RAN node the actual (measured) or inferred (predicted) Energy Cost (EC) values related to an offloading action. However, the EC values reported by the neighboring NG-RAN node could be affected by other actions, events, or factors which are unknown to the first NG-RAN node, e.g., another (concurrent) offloading action from a third NG-RAN node or new UEs arriving at, e.g., being handed over to, the neighboring NG-RAN node due to signal strength/quality reasons.

For example, assume that the first NG-RAN node wants to offload 20 User Equipments (UEs) to the neighboring NG-RAN node, which predicts that these additional 20 UEs would result in a certain increase of its EC. However, simultaneously with this action, a third NG-RAN node is also offloading 20 UEs to the same neighboring NG-RAN node. After the offloading has been executed and the neighboring NG-RAN node reports the actual (measured) energy consumption, the EC value will reflect a much higher impact on the energy consumption due to the system being unable to use some sleep modes or other network energy saving techniques as expected due to the higher load and UE/traffic activity, or due to the higher energy required to serve more UEs than the expected EC increase due to the planned offloading action from the first NG-RAN node, etc.

Several issues arise from this. A first issue is that the overall energy consumption of the network might have not reduced as originally intended since the first NG-RAN node was not aware of the third NG-RAN node's action. A second issue is that the first NG-RAN node might not be able to correctly assess the goodness of the offloading action after obtaining the measured EC as feedback since this EC value is affected both by its own action and by the third NG-RAN node's action.

Considering the above example, the EC value reported to the first NG-RAN node as feedback also reflects the offloading action of the third NG-RAN node (which the first NG-RAN node is unaware of) and may be much higher than expected. This causes two issues in particular. The first issue is that the first NG-RAN node either cannot use the EC feedback from the neighboring NG-RAN node to update its Artificial Intelligence (AI)/Machine Learning (ML) model, or potentially even worse, updates the AI/ML model with very noisy and misleading data causing the AI/ML model quality to deteriorate. The second issue is that, upon many occurrences of this type of situation, the first NG-RAN node may associate predictions from the neighboring NG-RAN node with low (er) quality and usefulness and not trust them in the future, which then leads to suboptimal network energy saving strategies.

A further issue that may arise with certain types of actions that result in an offloading action is that the real amount of traffic that will be transferred is not known beforehand, at the time of planning. For example, if a first NG-RAN node decides to deactivate a cell that provides coverage in certain area and offloads the active UEs to the neighboring NG-RAN node, it is inherently also offloading the UEs that will try to reconnect in the future when its cell is not active anymore. If its own prediction on the future traffic in the deactivated cell is inaccurate, the “additional load” signaled to the neighboring NG-RAN node will not match the real additional load the neighboring NG-RAN node will experience, and thus the measured EC will likely differ significantly from the predicted EC.

All the problems described here are not limited to energy consumption, and also apply to other types of measurements/predictions, e.g., resource utilization.

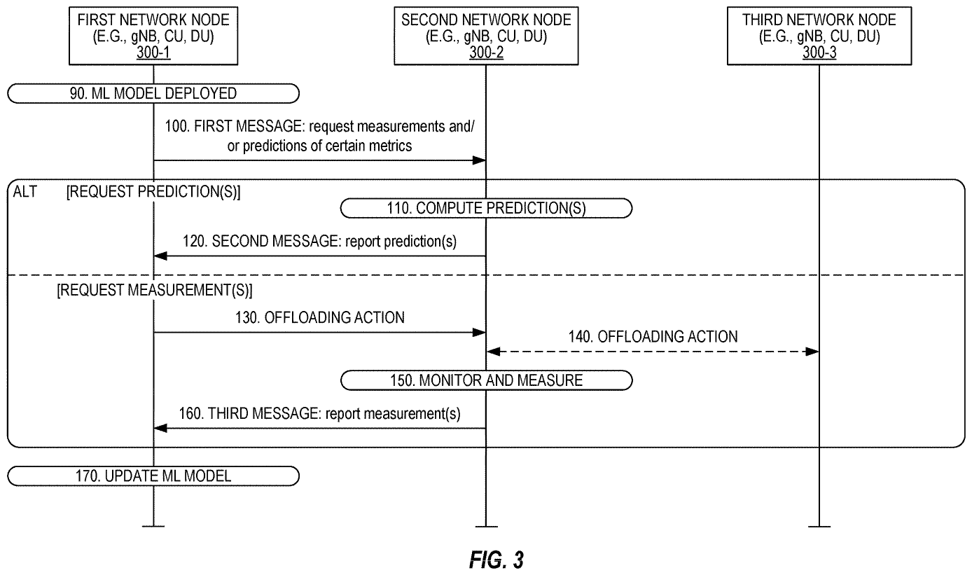

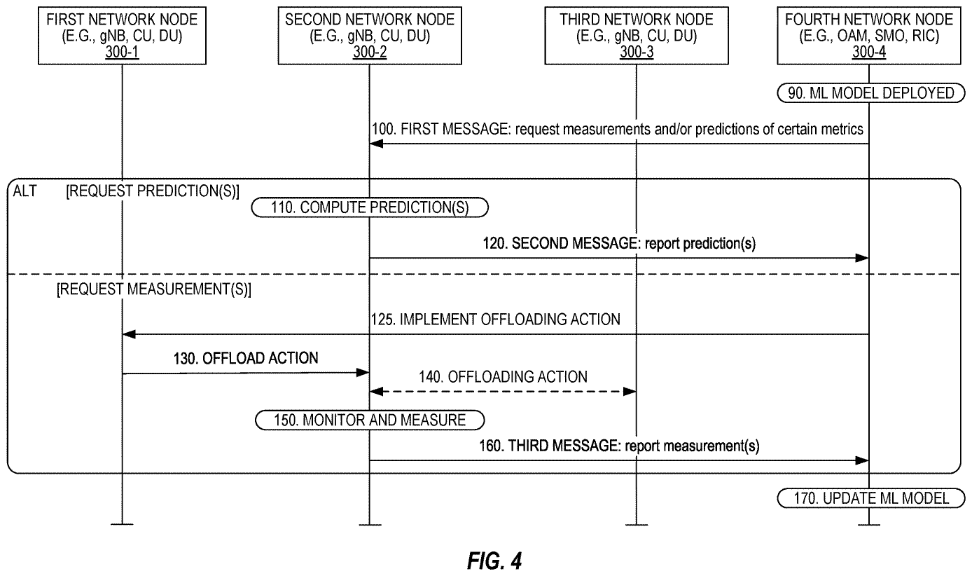

Certain aspects of the disclosure and their embodiments may provide solutions to these or other challenges. For the purpose of the present disclosure, a UE mobility and offloading (UMO) action is defined as an action where at least a UE and/or a certain load is transferred from one network node to another network, e.g., by handing over a UE to the other network node, reconfiguring a UE to multi-connectivity with the other network node, or by causing the UE to reconnect at the other network node, for example as in a release with redirection type of action. When the transfer involves a second network node and one or more third network nodes, the direction of the transfer is arbitrary, but in the case of the first and second network nodes, the load is always transferred between the first and the second network nodes, see steps 130 and 140 in FIG. 3 and FIG. 4. Further details are provided in Section 1 below.

The present disclosure describes embodiments of a method for a second network node to signal measurements and/or predictions of certain metrics, e.g., energy consumption/cost or resource utilization, to another network node in a disaggregated manner in relation to one or more UMO actions such that the effect of each UMO action is clear. Embodiments of the present disclosure therefore allow the receiver of the report to understand the contribution of the one or more UMO actions in the measured or predicted metrics, as well as the contribution that is independent of any UMO action. For example, if the first network node proposes to hand over several UEs to the second network node and requests the predicted EC of this UMO action, the second network node can report the predicted EC that is dependent on this UMO action separately from the predicted EC that is independent of this UMO action, i.e., the EC that the second network node predicts it would incur independently of the UMO action. Further details about the disaggregation levels are found in Section 4 below.

As illustrated in FIG. 3 and FIG. 4, embodiments of the present disclosure allow the reporting to be signaled to a first network node 300-1 (see FIG. 3) or to a fourth network node 300-4 (see FIG. 4). In the description below, reference to various “steps” are made to FIG. 3 or FIG. 4. Note that the same reference numbers are used in FIGS. 3 and 4 to the same or analogous steps.

In one embodiment, a method is provided for a second network node 300-2 to report measurements and/or predictions of certain metrics, e.g., energy consumption/cost or resource utilization, to another network node in a disaggregated manner (e.g., in one or more fractional amounts) in relation to one or more UMO actions (involving the second network node) and/or independent of any UMO action.

Referring to FIG. 3 and FIG. 4, in one embodiment, the method executed at the second network node 300-2 comprises any one or more steps of the following:
Receiving one or more FIRST MESSAGES (step 100), from either a first network node 300-1 (see FIG. 3) or a fourth network node 300-4 (see FIG. 4), with one or more requests for reporting measurements and/or predictions of certain metrics in relation to one or more UMO actions involving at least the second network node 300-2, the FIRST MESSAGE(S) also defining the one or more UMO actions.
   Note that, in one embodiment, there is a single FIRST MESSAGE with a request for reporting measurements and/or predictions of certain metrics in relation to one or more UMO actions involving at least the second network node 300-2. However, in another embodiment, there may be more than one FIRST MESSAGE with one or more requests for reporting measurements and/or predictions of certain metrics in relation to one or more UMO actions involving at least the second network node 300-2. For example, requests for reporting predictions and requests for reporting measurements may be handled via separate procedures, where the FIRST MESSAGES include one FIRST MESSAGE (during the procedure for reporting measurements) with a request for reporting a measurement(s) of a certain metric(s) in relation to one or more UMO actions involving the at least one second node and another FIRST MESSAGE with (during the procedure for reporting predictions) with a request for reporting a prediction(s) of a certain metric(s) (could be the same certain metric(s) as for the measurements) in relation to one or more UMO actions involving the at least one second node. Thus, it is to be understood that the FIRST MESSAGE referred to herein in regard to the description of the embodiments described herein (see, e.g., FIGS. 3, 4, 5, 6, and 7) can be a single FIRST MESSAGE or more than one FIRST MESSAGE (e.g., separate FIRST MESSAGES for requesting reporting of a measurement(s) and reporting of prediction(s).
Deriving, if requested, the predictions of the certain metrics in relation to the one or more UMO actions involving at least the second network node 300-2 (step 110).
Transmitting a SECOND MESSAGE, to either the first network node 300-1 or the fourth network node 300-4, with the requested predictions (step 120) in a disaggregated manner, such that the reported values reflect the contribution of each UMO action and the contribution that is independent of any UMO action in the certain metrics.
Receiving at least a UE and/or a certain load from the first network node 300-1 in relation to one or more of the one or more UMO actions specified in the FIRST MESSAGE (step 130), and potentially participating in other UMO actions with one or more third network nodes 300-3 (step 140).
Deriving, if requested, the measurements of the certain metrics in relation to the one or more UMO actions involving at least the second network node 300-2 (step 150).
Transmitting a THIRD MESSAGE, to either the first network node 300-1 or the fourth network node 300-4, with the requested measurements (step 160) in a disaggregated manner, such that the reported values reflect the contribution of each UMO action and the contribution that is independent of any UMO action in the certain metrics.

Further embodiments and details related to the first, second, and fourth network nodes as well as the FIRST MESSAGE, SECOND MESSAGE, and THIRD MESSAGE as well as any other messages between the said network nodes are described in Section 2 and Section 3 below.

Certain embodiments may provide one or more of the following technical advantage(s). Embodiments of the present disclosure may enable a network node to request and receive, from another network node, in the context of at least one executed or planned UMO action towards the other network node, more detailed information on measurements and/or predictions of certain metrics at the other network node, which has several advantages:
If a network node receives more detailed predictions of certain metrics at the other network node, it can correctly or adequately evaluate the (potential) outcome and/or benefit of the planned UMO action(s) even in the presence of other actions, events, or factors affecting the said metrics but unknown to the network node.
If a network node receives more detailed measurements of certain metrics at the other network node, it can correctly or adequately evaluate the (observed) outcome and/or benefit of the executed UMO action(s) even in the presence of other actions, events, or factors affecting the said metrics but unknown to the network node.
If a network node receives more detailed measurements of certain metrics at the other network node as feedback for the executed UMO action(s), it can use (make effective use of) the said feedback to update its AI/ML model even in the presence of other actions, events, or factors affecting the said metrics but unknown to the network node.
If a network node receives more detailed predictions and corresponding measurements of certain metrics at the other network node, it can correctly or adequately evaluate the accuracy/error of the predictions from the other network node, e.g., the performance of the AI/ML model at the other network node, even in the presence of other actions, events, or factors affecting the said metrics but unknown to the network node.
A network node, e.g., the first network node 300-1 or the fourth network node 300-4, may learn, as part of the information received in the SECOND MESSAGE and/or the THIRD MESSAGE, that another network node, e.g., the second network node 300-2, is affected by certain load/traffic patterns recurrently. This may enable the network node, e.g., the first network node 300-1 or the fourth network node 300-4, to learn how to better choose UMO actions also taking into account the load/traffic patterns due to interactions between the second network node 300-2 and other network nodes.

Further description regarding the operation of the various network nodes and the steps of FIGS. 3 and 4 are provided in the subsections below.

### 1 Definition of a UMO Action

A UE Mobility and Offloading (UMO) action is an action or set of actions where at least a UE and/or a certain load is transferred from a first network node 300-1 to a second network node 300-2 or between the second network node 300-2 and one or more third network nodes 300-3, e.g., by handing over a UE to the second or a third network node 300-3, reconfiguring a UE to multi-connectivity with the second or a third network node 300-3, or by causing the UE to reconnect at the second or a third network node 300-3, and may be realized (put into effect) by any one or more of the following:
Handover (of one or more UEs)
Future extensions of Layer 1 (L1)/Layer 2 (L2) Triggered Mobility (LTM) (of one or more UEs) for inter-node mobility
Radio Resource Control (RRC) release (of one or more UEs)
   Configuration of cell reselection priorities, etc.
RRC release with redirection (of one or more UEs)
   Configuration of redirected carrier info, etc.
RRC reconfiguration (of one or more UEs), e.g.,
   Addition, modification, or release of Secondary Cell(s) (SCell(s)
   Addition, modification, or release of a secondary cell group
   Delivery of dedicated/UE-specific system information influencing a particular UE's cell selection and reselection process
   Inter-Master Node handover with/without Secondary Node change
Modification of broadcasted and/or on-demand provided system information influencing all UEs' cell selection and reselection process
Cell deactivation or activation
Synchronization Signal Block (SSB) beam deactivation or activation
Modification of a downlink output power, e.g., of an SSB beam
Modification of an antenna tilt
Modification of a mobility/handover trigger setting

A UMO action may affect one or more or all UEs served by a network node.

A UMO action may affect a fractional amount of load or the full amount of load of a network node.

A UMO action type indicates a set of UMO actions, grouped based on at least one common characteristic. For instance:
a first type of UMO action can indicate a group of UMO actions which are related to (put into effect by) a “mobility due to coverage optimization”. This can group, e.g., UMO actions due to a cell deactivation/activation, or SSB beam deactivation/activation, or modification of DL output power, or modification of antenna tilt).
a second type of UMO action can indicate a group of UMO actions related to “mobility due to load balancing”. This can group, e.g., UMO actions due to modification of mobility/handover trigger setting.
a third type of UMO action can indicate a group of UMO actions related to “mobility due to coverage”. This can group, e.g., UMO actions due to poor coverage, or LTM.
a fourth type of UMO action can indicate a group of UMO actions related to “traffic steering”. This can group, e.g., UMO actions caused by RRC Release/Release with redirection.
a fifth type of UMO action can indicate a group of UMO actions related to “multi-connectivity”. This can group, e.g., UMO actions related to use of dual connectivity.
a sixth type of UMO action can indicate a group of UMO actions related to “mobility due to Network Energy Saving”. This can group, e.g., UMO actions that are aimed at reducing energy consumption at a network node or group of network nodes level.

In the remainder of the description, the methods described for UMO actions can equally apply to UMO action types as well.

### 2 Embodiments Related to the Network Nodes

### 2.1 Embodiments Related to the Second Network Node

Embodiments of a method for a second network node 300-2 to report measurements and/or predictions of certain metrics, e.g., energy consumption/cost or resource utilization, to another network node in a disaggregated manner (e.g., in one or more fractional amounts) in relation to one or more UMO actions (involving the second network node 300-2) and/or independent of any UMO action are disclosed.

In one embodiment, the method executed at the second network node 300-2 comprises any one or more steps of the following, where references are made to FIG. 3 and FIG. 4:
Receiving a FIRST MESSAGE (step 100), from either a first network node 300-1 (see FIG. 3) or a fourth network node 300-4 (see FIG. 4), with a request for reporting measurements and/or predictions of certain metrics in relation to one or more UMO actions involving at least the second network node 300-2, the FIRST MESSAGE also defining the one or more UMO actions (the latter is detailed in Section 1). The request can indicate, in an explicit or in an implicit manner, that the requested measurements and/or predictions are to be reported with a granularity of at least one of the disaggregation levels defined in Section 4.
Deriving, if requested, the predictions of the certain metrics in relation to the one or more UMO actions involving at least the second network node 300-2 (step 110).
Transmitting a SECOND MESSAGE, to either the first network node 300-1 (see FIG. 3) or the fourth network node 300-4 (see FIG. 4), with the requested predictions (step 120) in a disaggregated manner, such that the reported values reflect the contribution of each UMO action and (optionally) the contribution that is independent of any UMO action in the certain metrics.
   As an alternative, the predictions signaled in the SECOND MESSAGE may only concern one or more of the UMO actions described in the FIRST MESSAGE.
Receiving at least a UE and/or a certain load from the first network node 300-1 in relation to one or more of the UMO actions specified in the FIRST MESSAGE (step 130), and potentially participating in other UMO actions with one or more third network nodes 300-3 (step 140).
Deriving, if requested, the measurements of the certain metrics in relation to the one or more UMO actions involving at least the second network node 300-2 (step 150).
Transmitting a THIRD MESSAGE, to either the first network node 300-1 (see FIG. 3) or the fourth network node 300-4 (see FIG. 4), with the requested measurements (step 160) in a disaggregated manner, such that the reported values reflect the contribution of each UMO action and (optionally) the contribution that is independent of any UMO action in the certain metrics.
   In one embodiment, the measurements may be made of two parts, for example, in the case of EC, namely the measured delta EC due to the full or partial offloading that took place as part of the one or more UMO actions and the total EC consumed at the second node after the UMO actions were carried out.

In one embodiment, after deriving the predictions, the second network node 300-2 may accept or reject one or more of the UMO actions defined in the FIRST MESSAGE. Alternatively, it may partly accept one or more of the UMO actions in conjunction to a disaggregated level, for example, it may accept a group of UEs that, based on the predicted metrics, will not cause an overload and/or excessive EC at the second network node 300-2. The second network node 300-2 could indicate a preferred disaggregation level to show which UEs and/or UMO action(s) it can or does accept and which it cannot or does not accept.

In one embodiment, the second network node 300-2 can identify the UEs offloaded as part of the one or more UMO actions because it receives information, either from the first network node 300-1 or from the one or more involved UEs, about the fact that the mobility procedure is part of one of the UMO actions described in the FIRST MESSAGE. As an example, an identifier may identify the UMO action described in the FIRST MESSAGE and the same identifier may be present in the signaling to offload traffic for that UMO action from the first network node 300-1 to the second network node 300-2 (e.g., in the Handover Request message).

In one embodiment, the second network node 300-2 receives an explicit signaling (after the UMO action(s) have been fully or partially completed, in step 130) to start the monitoring and measurement process of step 150. In another embodiment, the signaling to start the monitoring and measurement process is implicit, and the second network node 300-2 starts the monitoring and measurement process as soon as it detects that the UMO action(s) have been fully or partially completed.

### 2.2 Embodiments Related to the First Network Node

Embodiments of a method for a first network node 300-1 to request measurements and/or predictions of certain metrics, e.g., energy consumption/cost or resource utilization, from a second network node 300-2 in a disaggregated manner (e.g., in one or more fractional amounts) in relation to one or more UMO actions (involving the second network node 300-2) and/or independent of any UMO action are also disclosed.

In one embodiment, the method executed at the first network node 300-1 comprises any one or more steps of the following, with references being made to FIG. 3 and FIG. 4:
Deriving one or more (potential) UMO actions towards the second network node 300-2, e.g., using the AI/ML model deployed in step 90 (cf. FIG. 3), the UMO actions deemed beneficial for one or more reasons, e.g., for reducing the energy consumption/cost at the first network node 300-1 and/or the overall energy consumption/cost of the (local) network, or improving the QoS/QoE for/of one or more UEs.
   For further clarification, in embodiments, the first network node 300-1 may have an AI/ML model that predicts its own node-level energy consumption in for example the next 5 minutes. This model could for example be a linear regressor, a random forest regressor, or a neural network. The inputs to the models could for example be one or more of: number of active UEs at the first network node 300-1 (optionally, disaggregated per traffic type, e.g., VoIP, VOD (Video-on-Demand), web, etc.), the recent resource utilization, the time of day and day of week, etc. Using the AI/ML model, i.e., based on the output provided by AI/ML model inference, the first network node 300-1 may find that by offloading some UEs (which reduces the number of active UEs), the energy consumption of the first network node 300-1 can be significantly reduced. Finding a suitable group of UEs which can be offloaded to the second network node 300-2 is an example of what herein is referred to as deriving one or more (potential) UMO actions towards the second network node 300-2.
Transmitting a FIRST MESSAGE (step 100), to the second network node 300-2, with a request for reporting measurements and/or predictions of certain metrics in relation to one or more UMO actions involving at least the second network node 300-2, the FIRST MESSAGE also defining the one or more UMO actions. The request can indicate, in an explicit or in an implicit manner, that the requested measurement(s) and/or prediction(s) is (are) to be provided with a granularity of at least one of the disaggregation levels defined in 0.
Receiving a SECOND MESSAGE, from the second network node 300-2, with the requested predictions (step 120) in a disaggregated manner, such that the reported values reflect the contribution of each UMO action and (optionally) the contribution that is independent of any UMO action in the certain metrics.
Implementing the system changes that result in the selected UMO action(s) (step 130).
   Note that step 130 (implementing the system changes) is optional. Based on the prediction(s) received in the SECOND MESSAGE, the first network node 300-1 may conclude that the system change(s) will not be beneficial for the overall network state, e.g., they will not lead to an overall energy saving gain, they will lead to an overload at the second network node 300-2, etc. If the system change(s) are foreseen not to improve the overall network state, the first network node 300-1 will not implement them. In that case the UMO actions between the first and second network node 300-2 are not taken, but the second network node 300-2 can still report measurements (measurement contributions) related to UMO actions between the third and second network node 300-2, if any, or at least measurements independent of any UMO actions.
Receiving a THIRD MESSAGE, from the second network node 300-2, with the requested measurements (step 160) in a disaggregated manner, such that the reported values reflect the contribution of each UMO action and (optionally) the contribution that is independent of any UMO action in the certain metrics.

In one embodiment, upon reception of the SECOND MESSAGE with the reported prediction(s) of the certain metrics in step 120, the first network node 300-1 may decide to not carry out the system changes that lead to the proposed UMO action(s), which results in the UMO action(s) being aborted/cancelled/stopped. For example, if the UMO action was a cell deactivation that would have resulted in several UEs being handed over to the second network node 300-2, and the second network node 300-2 predicts that the EC will be high, the first network node 300-1 may conclude that it is not beneficial to deactivate its cell and does not proceed with the cell deactivation.

In another embodiment, the first network node 300-1 may have defined several UMO actions in the FIRST MESSAGE, and upon reception of the SECOND MESSAGE with the reported prediction(s) of the certain metrics in step 120, the first network node 300-1 may choose to carry out one or more of them. The first network node 300-1 implements the system changes that result in the chosen UMO action(s) towards the second network node 300-2 in step 130.

In another embodiment, the first network node 300-1 may have defined several UMO actions in the FIRST MESSAGE, and upon reception of the reported prediction(s) of the certain metrics in step 120, the first network node 300-1 may choose to carry out revised versions of one or more of them. Alternatively, upon reception of the reported predictions, the first network node 300-1 may derive new UMO action(s) that should be carried out. The first network node 300-1 implements the system changes that result in the chosen UMO action(s) towards the second network node 300-2 in step 130.

In another embodiment, upon reception of the THIRD MESSAGE with the reported measurement(s) of the certain metrics in step 160, the first network node 300-1 may decide to revert (partially or completely) the system changes that resulted in the UMO action(s).

In another embodiment, upon reception of the reported measurement(s) and/or prediction(s) of the certain metrics, the first network node 300-1 may decide to update (in step 170) the ML model used to derive the UMO action(s).

In one embodiment, the first network node 300-1 transmits an explicit signaling (after the UMO action(s) have been fully or partially completed, in step 130) to the second network node 300-2 to start the monitoring and measurement process of step 150. In another embodiment, the signaling to start the monitoring and measurement process is implicit in the signaling to carry out the UMO action(s). The signaling can also contain an indication or a condition as to when to stop the measurement and reporting.

### 2.3 Embodiments Related to the Fourth Network Node

Embodiments of a method for a fourth network node 300-4 to request measurements and/or predictions of certain metrics, e.g., energy consumption/cost or resource utilization, from a second network node 300-2 in a disaggregated manner (e.g., in one or more fractional amounts) in relation to one or more UMO actions (involving the second network node 300-2) and/or independent of any UMO action are also disclosed.

In one embodiment, the method executed at the fourth network node 300-4 comprises any one or more steps of the following, with reference being made to FIG. 4:
Deriving one or more (potential) UMO actions from a first network node 300-1 towards the second network node 300-2, e.g., using the AI/ML model deployed in step 90 (cf. FIG. 4), the UMO actions deemed beneficial for one or more reasons, e.g., for reducing the energy consumption/cost at the first network node 300-1 and/or the overall energy consumption/cost of the (local) network, or improving the QoS/QoE for/of one or more UEs.
Transmitting a FIRST MESSAGE (step 100), to the second network node 300-2, with a request for reporting measurements and/or predictions of certain metrics in relation to one or more UMO actions involving at least the second network node 300-2, the FIRST MESSAGE also defining the one or more UMO actions.
Receiving a SECOND MESSAGE, from the second network node 300-2, with the requested predictions (step 120) in a disaggregated manner, such that the reported values reflect the contribution of each UMO action and (optionally) the contribution that is independent of any UMO action in the certain metrics.
Signaling to the first network node 300-1 an indication to implement the system changes that result in the selected UMO action(s) (step 125). Such changes may, for example, consist in starting procedures to implement the offloading actions described in the one or more UMO actions.
Receiving a THIRD MESSAGE, from the second network node 300-2, with the requested measurements (step 160) in a disaggregated manner, such that the reported values reflect the contribution of each UMO action and (optionally) the contribution that is independent of any UMO action in the certain metrics.

In one embodiment, upon reception of the SECOND MESSAGE with the reported prediction(s) of the certain metrics in step 120, the fourth network node 300-4 may decide to not carry out the system changes that lead to the proposed UMO action(s), which results in the UMO action(s) being aborted/cancelled/stopped. For example, if the UMO action was a cell deactivation that would have resulted in several UEs being handed over to the second network node 300-2, and the second network node 300-2 predicts that the EC will be high, the fourth network node 300-4 may conclude that it is not beneficial to deactivate the first network node 300-1's cell and does not proceed with the cell deactivation.

In another embodiment, the fourth network node 300-4 may have defined several UMO actions in the FIRST MESSAGE, and upon reception of the SECOND MESSAGE with the reported prediction(s) of the certain metrics in step 120, the fourth network node 300-4 may choose to carry out one or more of them. The fourth network node 300-4 signals to the first network node 300-1 the needed system changes that will result in the chosen UMO action(s) in step 125.

In another embodiment, the fourth network node 300-4 may have defined several UMO actions in the FIRST MESSAGE, and upon reception of the reported prediction(s) of the certain metrics in step 120, the fourth network node 300-4 may choose to carry out revised versions of one or more of them. Alternatively, upon reception of the reported predictions, the fourth network node 300-4 may derive new UMO action(s) that should be carried out. The fourth network node 300-4 signals to the first network node 300-1 the needed system changes that will result in the chosen UMO action(s) in step 125.

In another embodiment, upon reception of the THIRD MESSAGE with the reported measurement(s) of the certain metrics in step 160, the fourth network node 300-4 may decide to revert (partially or completely) the system changes in the first network node 300-1 that resulted in the UMO action(s).

In another embodiment, upon reception of the reported measurement(s) and/or prediction(s) of the certain metrics, the fourth network node 300-4 may decide to update (in step 170) the ML model used to derive the UMO action(s).

In some embodiments, the method described herein may be applied concurrently between the second and a third network node 300-3, wherein the second network node 300-2 takes the role of a first network node 300-1, and the third network node 300-3 takes the role of a second network node 300-2.

In this case, the fourth network node 300-4 may concurrently derive one or more (potential) UMO actions from the second network node 300-2 towards at least one third network node 300-3 and transmit a FIRST MESSAGE to the third network node 300-3, the FIRST MESSAGE defining the UMO actions and comprising a request for reporting predictions of certain metrics in relation to the UMO actions.

Note that “concurrently” here means concurrent to deriving one or more (potential) UMO actions from the first network node 300-1 towards the second network node 300-2 and transmitting a FIRST MESSAGE to the second network node 300-2 (cf. FIG. 4 and Section 2.3).

After receiving the predictions from the third network node 300-3 in a SECOND MESSAGE, and optionally after receiving predictions from the second network node 300-2 in a SECOND MESSAGE, the fourth network node 300-4 may signal to the second network node 300-2 to carry out one or more of the UMO actions. In that way the second network node 300-2 can offload some UEs/load to a third network node 300-3, e.g., further away from the first network node 300-1, while at the same time accepting UEs/load from the first network node 300-1, which is orchestrated by the fourth network node 300-4 in this case.

Finally, after the UMO actions are carried out, both the second and third network nodes 300-2 and 300-3 will/may send a THIRD MESSAGE with measurements to the fourth network node 300-4, if requested to do so.

### 2.4 Additional Scenarios

In some embodiments, the methods described in relation to FIG. 3 and FIG. 4 can be extended as follows.

### 2.4.1 Scenario 3: Fourth Network Node Configuring the Disaggregation Levels and Receiving the Measurements and the Predictions.

The fourth network node 300-4 is the node hosting the ML model (as in FIG. 4) and, for example, it corresponds to an OAM/SMO node (or OAM/SMO function). The fourth network node 300-4 sends a configuration to the first network node 300-1, containing the disaggregation levels required/possible/recommended for the measurements and/or predictions to be collected.

The first network node 300-1 plays a similar role as in FIG. 3; however, it does not host an ML Model and it does not collect data (measurements and/or predictions) for itself, but rather for the fourth network node 300-4. In a possible variation, the first network node 300-1 indeed hosts an ML model (as shown in FIG. 3) and, as just described, it receives the indications/configurations related to the disaggregation level(s) from the fourth network node 300-4 and provides the measurements and/or predictions accordingly. In addition to that, it also uses the same measurements and/or predictions for itself. For example, the first network node 300-1 does so to refine the ML model deployed by the fourth network node 300-4 (e.g., the first network node 300-1 is a RAN node allowed to continue model training based on the ML model trained in the OAM).

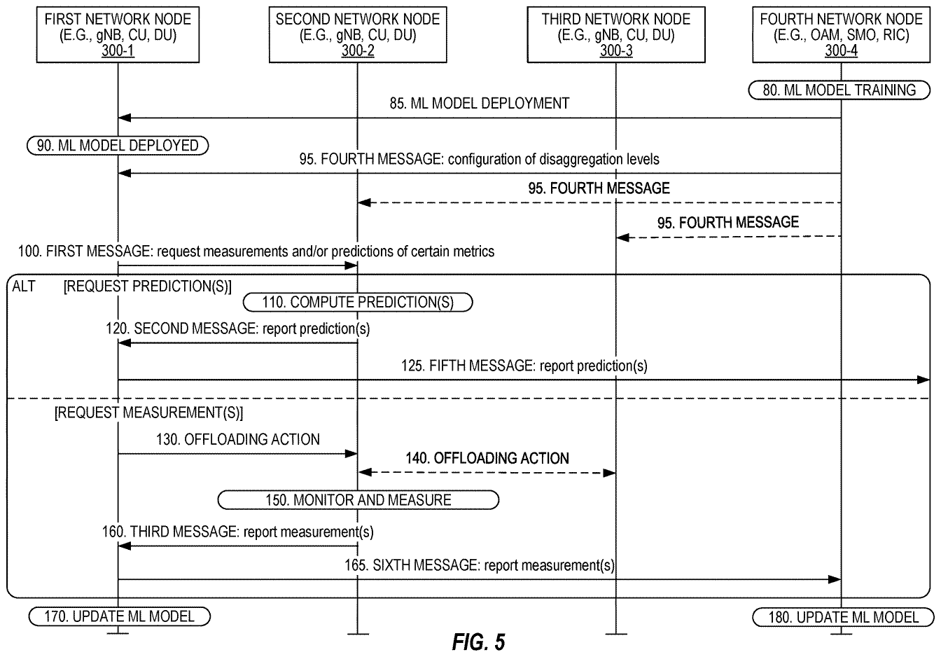

In this scenario, the same methods as described in the other scenarios of FIG. 3 and FIG. 4 apply, with the following remarks and additions, examples of which are illustrated in FIG. 5:
The fourth network node 300-4 trains the ML model (step 80) and communicates with the first network node 300-1 to deploy the (trained) ML model at the first network node 300-1 (steps 85 and 90).
The fourth network node 300-4 sends to (or configures) the first network node 300-1 (and/or the second network node 300-2 and/or the third network node 300-3) with information concerning the disaggregation levels to be used. This information can be sent in one or more FOURTH MESSAGE(s) (step(s) 95).
The first network node 300-1 sends the FIRST MESSAGE to the second network node 300-2 (step 100).
The second network node 300-2 computes the prediction(s) (step 120) and sends the SECOND MESSAGE to the first network node 300-1 or to the fourth network node 300-4 (step 120)
   If the SECOND MESSAGE goes to the first network node 300-1 (as illustrated in the example of FIG. 5), the fourth network node 300-4 can receive the predictions included in the SECOND MESSAGE by means of another message (FIFTH MESSAGE), whose content is substantially the same as the SECOND MESSAGE. The FIFTH MESSAGE is sent from the first network node 300-1 to the fourth network node 300-4 (step 125).
The second network node 300-2 sends the THIRD MESSAGE to the first network node 300-1 (step 160) or to the fourth network node 300-4 (not shown in the example of FIG. 5).
   If the THIRD MESSAGE goes to the first network node 300-1 as shown in the example of FIG. 5, the fourth network node 300-4 can receive the measurements included in the THIRD MESSAGE by means of another message (SIXTH MESSAGE), whose content is substantially the same as the THIRD MESSAGE. The SIXTH MESSAGE is sent from the first network node 300-1 to the fourth network node 300-4 (step 165).

In this scenario, the first network node 300-1 may update the ML model with its own local data; at the same time, the fourth network node 300-4 may update the ML model with data coming from a multitude of first networks node 300-1 carrying out an embodiment of the method described herein.

2.4.2 Scenario 4: Exchanging Information about the Supported Disaggregation Levels Prior to Sending the FIRST MESSAGE.

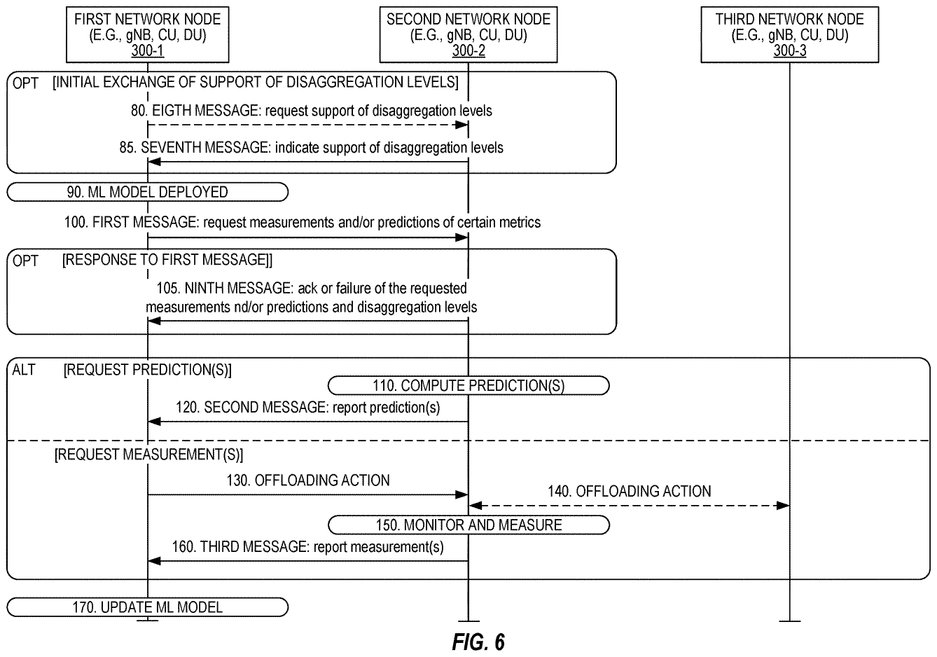

In one embodiment, the second network node 300-2 indicates its support of measurements and/or predictions according to different disaggregation levels in a SEVENTH MESSAGE before the main method starts, see step 85 in the example embodiment of FIG. 6.

In one embodiment, the first network node 300-1 (or fourth network node 300-4) requests in an EIGHTH MESSAGE the second network node to report the supported disaggregation levels for certain measurements and/or predictions, see step 80 in FIG. 6. Upon receiving this request, the second network node 300-2 responds by indicating all or (preferred) disaggregation level(s) for the measurements/predictions it can provide in the SEVENTH MESSAGE.

In another embodiment, the first network node 300-1 (or fourth network node 300-4) indicates in the EIGHTH MESSAGE one or more disaggregation level for each of the measurement and/or predictions and requests the second network node 300-2 to indicate the one or more disaggregation levels that are supported by the second network node 300-2. Upon receiving this request, the second network node 300-2 responds by indicating all or (preferred) disaggregation level(s) for the measurements/predictions that are supported, and/or the ones that are not supported, in the SEVENTH MESSAGE.

### 2.4.3 Scenario 5: Second Network Node Acknowledges the FIRST MESSAGE.

In one embodiment, upon reception of the FIRST MESSAGE, the second network node 300-2 indicates, in a NINTH MESSAGE, which of the requested measurements and/or predictions can be provided according to the requested disaggregation level(s), see step 105 in FIG. 6.

In one embodiment, the NINTH MESSAGE indicates that one or more of the requested disaggregation levels is not supported, or that one or more of the requested disaggregation levels is supported for measurements but not for predictions (or vice versa), or that a first group of one or more disaggregation levels is supported for measurements and a second group of one or more disaggregation levels is supported for predictions.

### 2.4.4 Scenario 6: a Priori Configuration of Some/all of the Information in the THIRD MESSAGE

In this embodiment, at least part of the information reported in the THIRD MESSAGE is configured a priori by the first network node or the fourth network node.

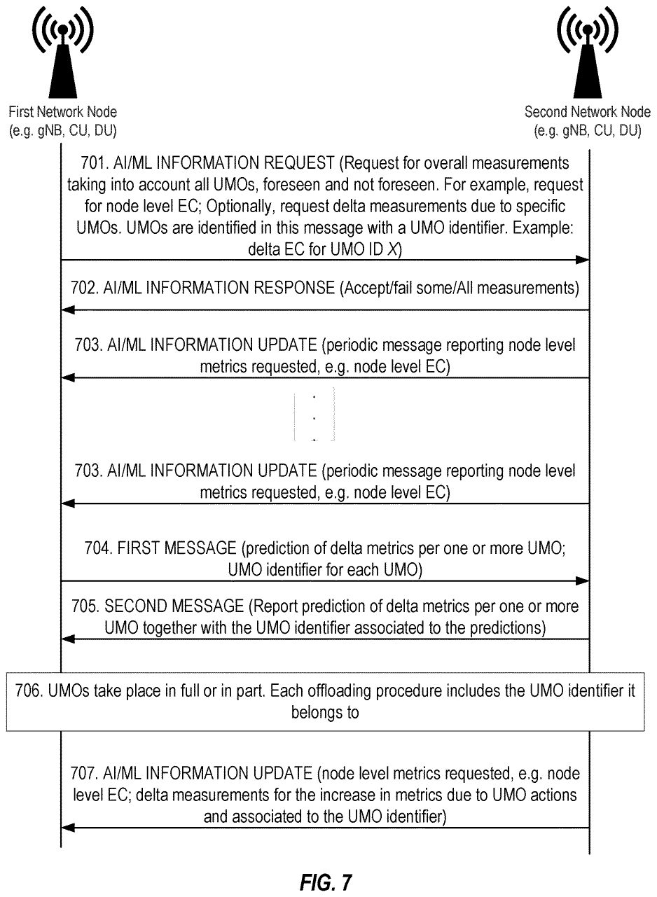

In the example of this scenario illustrated in FIG. 7, the first network node is taken as the node that configures the information a priori.

The steps of the process of FIG. 7 are as follows:
Step 701: The first network node signals to the second network node a request for overall measurements taking into account all UMO actions, foreseen and not foreseen. For example, a request for node level EC taking all factors affecting the EC into account. Optionally, the first network node may request delta measurements due to specific UMO actions, for example the delta measurement of EC due to the offloading of traffic that is part of a UMO action. UMO actions are identified in this message with a UMO identifier.
Step 702: The second network node responds to the request by accepting or failing part/all of the requested measurements.
Step 703: The second network node reports periodically measurements that have been requested to be reported periodically, such as the per node level measurements, e.g., node level EC. Note that the node level EC may also be requested to be reported for a specific UMO action, i.e., after the specific UMO actions is complete.
Step 704: The first network node requests to the second network node to report delta metrics per one or more UMO actions, where each requested delta metric is associated to a signaled UMO identifier. For example, the first network node requests a delta EC prediction for a given amount of load to be offloaded from Cell A to Cell B.
Step 705: The second network node responds with the requested predictions, associated to an identifier (a UMO identifier).
Step 706: UMO actions (e.g., HOs) take place to offload the traffic from the first network node to the second network node. Each procedure to offload traffic from the first network node to the second network node includes the UMO identifier, which can be called, for example, AI-ML Event Information. The value of this identifier is the same as included in the UMO action description in the FIRST MESSAGE (step 704). With this, the second network node knows exactly what load was offloaded as part of the UMO described in the FIRST MESSAGE. As an example, only half of the load described for a given UMO action may, in practice, be offloaded. This helps in calculating the actual delta measurements for metrics associated to an UMO action, e.g., it enables to calculate an EC delta due to offloading of a given traffic belonging to a UMO action.
Step 707: The second network node signals to the first network node the measurements, e.g., a measurement of the EC at node level. The second network node also signals to the first network node the delta measurements associated to the offloading for each UMO action, e.g., the delta for the EC caused by offloading belonging to a specific UMO action.

With the embodiment above, the first network node can deduce the following:
The overall per node metrics measured at the second network node, independently of the UMO actions described to the second network node in the FIRST MESSAGE. Namely the first network node learns how such metrics are affected by actions that were not foreseen. As an example, the first network node may learn the node level Energy Cost at the second network node, taking into account all traffic dynamics at the second network node. This can be used to build a pattern of EC along time and predict the energy status in time at the second network node.
Delta metrics for the specific offloaded traffic belonging to each UMO action, e.g., delta ECs for the specific offloaded UEs associated to an UMO action. This can be used as reward to the AI/ML algorithm.

### 3 Embodiments Related to the Messages

### 3.1 Embodiments Related to the FIRST MESSAGE

In one embodiment, the FIRST MESSAGE defines the certain metrics to be measured and/or predicted. Some non-limiting examples are:
energy consumption/cost at the network node.
resource utilization at the network node (as, for example, defined in the existing Resource Status Reporting XnAP/F1AP/E1AP procedure)·
UE performance (e.g., certain statistics such as average, median, percentiles), e.g., throughput, packet delay, packet loss, RVQoE metrics, etc.

In a related embodiment, the metrics to be measured are different than the metrics to be predicted. For example, when proposing a UMO action, the first network node requires the prediction of both the EC at the second network node and the UE performance for the offloaded UEs; however, after the UMO action has been carried out, the first network node is only interested in obtaining the measured EC at the second network node.

In one embodiment, the FIRST MESSAGE defines the different disaggregation levels to be used for the measurement and/or prediction of the certain metrics. The definition and details of the disaggregation levels are found in Section 4.

In a related embodiment, the disaggregation levels used for the measurements are different than the disaggregation levels used for predictions. For example, when proposing a UMO action, the first network node requires the prediction of the EC at the second network node split between the EC related to the UMO action and the EC independent of it; however, after the UMO action has been carried out, the first network node is interested in obtaining the measured EC at the second network node split between the EC related to the UMO action, the EC related to UMO actions by third network nodes, and the EC independent of any UMO action.

In a related embodiment, the disaggregation levels used for each of the requested measurements and/or predictions may be different. For example, when proposing a UMO action, the first network node requires the prediction of the EC at the second network node to be split between the EC related to this particular UMO action and the EC independent of it; however, it also requires the prediction of radio resource utilization to be split among all UMO actions (i.e., the one proposed by the first network node, and potentially other known UMO actions involving one or more third network nodes).

In one embodiment, the FIRST MESSAGE defines how the disaggregation should be computed/estimated by the second network node. For example, in measuring/predicting energy consumption, if part of the energy consumption is independent of the traffic load, the FIRST MESSAGE could specify that this load-independent energy consumption should be split proportionally among the load due the UMO action(s) from the first network node and the rest of the load experienced by the second network node.

In one embodiment, the FIRST MESSAGE indicates a list of disaggregation levels according to which reporting of measurements and/or predictions is possible/acceptable. The second network node, when providing the corresponding reports in the SECOND MESSAGE and/or in the THIRD MESSAGE, it indicates the disaggregation level to which the measurements and/or the predictions refer to.

In one embodiment, the FIRST MESSAGE indicates more than one disaggregation levels, each disaggregation level being associated to certain characteristic(s) associated to UMO actions. For instance, the first network node or the fourth network node may want to specify: 1) a first disaggregation level to obtain measurements and/or predictions related to individual UE for which the UMO action is initiated by the first network node, and 2) a second disaggregation level to obtain measurements and/or predictions related to all the UMO actions not initiated by the first network node.

In one embodiment, the FIRST MESSAGE indicates how the second network node should report information specifically for the UMO actions in which the second network node is involved in and the first network node is not aware or part of. For those actions, the first (or fourth) network node may request one or more of the following:
An indication of the contribution of each of the UMO actions with an explicit or implicit indication defining the UMO action.
An indication of the contribution of each of those actions without exposing the UMO actions. In this case, the second network node reports a list of contributions without specifying the corresponding actions.
The total contribution of those actions without specifying the actions. Additionally, the second network node might be requested to indicate the number of actions for which the reported contribution corresponds.

In a related embodiment, the fourth network node configures both the first and the second network nodes with a list of UMO actions and an identifier for each of those UMO actions. The second network node refers to that list to indicate a contribution for an UMO action that is not directly involving the first network node but has an impact on the requested measurements and/or predictions. An example configured list indicates action index 1 refers to a Handover action, action index 2 refers to a cell activation action, etc. If concurrently with the implementation of the UMO action, one or more UEs are handed over from a third network node to the second network node, the latter indicates action index 1 and the corresponding contribution of that action on the reported measurement. The first network node becomes aware of the occurrence of an offloading action involving the second network node and contributing to the obtained measurement.

In a related embodiment, the fourth network node configures both the first and the second node with index per group of UMO actions, similar to the UMO action type described in Section 1. The grouping can be based on different use cases (energy saving actions, load balancing actions, etc.).

In one embodiment, wherein a first network node or a fourth network node requests measurements and/or predictions of certain metrics from a second network node, the FIRST MESSAGE specifies one or more identifiers associated to the one or more proposed UMO actions.

In a related embodiment, the one or more identifiers associated to the one or more proposed UMO actions signaled in the FIRST MESSAGE are used in the subsequent signaling between the first and second network nodes, e.g., included in the messages for the handover procedure in step 130. In this way, the first network node may implicitly signal to the second network node that the identified UMO action(s) have been carried out.

In a related embodiment, upon reception of the one or more identifiers associated to the one or more proposed UMO actions in the subsequent signaling between the first and second network nodes, the second network node knows that it needs to start monitoring and measuring the requested certain metrics. The identification of offloaded UEs using the one or more identifiers associated to the one or more proposed UMO actions can be used by the second network node to obtain/compute/measure the different contributions to be reported in the different disaggregation levels. Further details about the disaggregation levels are found in Section 4.

In one embodiment, the FIRST MESSAGE is signaled from the first or fourth network node to the second network node as a unique message. In another embodiment, the FIRST MESSAGE is signaled from the first or fourth network node to the second network node in multiple messages.

In one embodiment, the FIRST MESSAGE is signaled from the first or fourth network node to the second network node directly. In another embodiment, the FIRST MESSAGE is signaled from the first or fourth network node to the second network node passing through one or more intermediary nodes, e.g., the FIRST MESSAGE may be signaled from the fourth network node to the second network node passing through the first network node.

An example when the FIRST MESSAGE is signaled directly from the first network node to the second network node is when the first network node and the second network node are both RAN node. An example when the FIRST MESSAGE is signaled from the fourth network node to the second network node through the first network node is when the first network node is a gNB-CU, the second network node is a gNB-DU controlled by the gNB-CU, and the fourth network node is a Near-Real-Time RIC (or an SMO).

### 3.2 Embodiments Related to the SECOND MESSAGE

In one embodiment, the SECOND MESSAGE is signaled from the second network node to the first or fourth network node as a unique message. In another embodiment, the SECOND MESSAGE is signaled from the second network node to the first or fourth network node in multiple messages. The subsequent messages can contain either the full report or a delta (for the certain metrics) related to the previous one.

In one embodiment, the SECOND MESSAGE is signaled from the second network node to the first or fourth network node directly. In another embodiment, the SECOND MESSAGE is signaled from the second network node to the first or fourth network node passing through one or more intermediary nodes, e.g., the SECOND MESSAGE may be signaled from the second network node to the fourth network node passing through the first network node.

In one embodiment, the SECOND MESSAGE indicates the disaggregation level(s) to which the predictions refer to.

In one embodiment, the SECOND MESSAGE could contain, in addition to or instead of the requested predictions of the certain metrics, an indication of acceptance or rejection of one or more of the one or more UMO actions defined in the FIRST MESSAGE. Alternatively, it could indicate a preference of certain UMO actions over others, for example, by including a preference score (e.g., a value between 0 and 100 where 100 indicates “most preferred”) to each UMO action or by ordering the UMO actions from most preferred to least preferred. In one embodiment, the SECOND MESSAGE contains both measurements and predictions.

### 3.3 Embodiments Related to the THIRD MESSAGE

The embodiments related to the SECOND MESSAGE also apply to the THIRD MESSAGE, where predictions should be understood as measurements in the context of this message.

In one embodiment, the THIRD MESSAGE contains both measurements and predictions.

### 3.4 Embodiments Related to Other Messages

As previously described in Section 2.4.4 “Scenario 6”, in one embodiment, the first network node (e.g., before initiating the herein-described procedures to request and receive predictions, in a FIRST MESSAGE and a SECOND MESSAGE, respectively) can request the second network node to report certain measurements by means of another procedure, e.g., via an AI/ML INFORMATION REQUEST message to the second network node. This means that, in one embodiment, the information to be reported in the THIRD MESSAGE is configured in yet another message.

Such information may be metrics like energy consumption (or Energy Cost) at node level, i.e., concerning the entire network node, or as delta concerning at least one UMO action, e.g., the Energy Cost caused by UEs/traffic that was/is part of the UMO action. The UMO action may be identified via an identifier, e.g., a common identifier, comprised in the said request message, e.g., in the so-called AI/ML INFORMATION REQUEST message, and in at least one message exchanged as part of at least one procedure to execute the said UMO action.

In yet another embodiment, the information to be reported in the THIRD MESSAGE is configured in yet another message, signaled from the fourth network node to the second network node, prior to the FIRST MESSAGE. This message may carry a request for the second network node to report actual measurements, e.g., a request for the Energy Cost due to the offloading of UEs/traffic by means of procedures that carry a certain identifier. Such identifier is present in this message, and it is also present in the procedures to offload the UEs/traffic from the first network node to the second network node. This message, again, signaled from the fourth network node to the second network node, may also carry a request for the second network node to report total node-level measurements, e.g., the Energy Cost of the entire second network node.

### 4 Disaggregation Levels

When reporting the measurements and/or predictions of the certain metrics, the second network node divides the total measured and/or predicted value in different components; we refer to this as disaggregation levels. Some possible non-limiting examples of disaggregation levels are:
Relating to one or more UMO actions from the first network node towards the second network node or independent of these UMO actions.
Relating to one or more UMO actions involving the second network node and one or more third network nodes.
Relating to all the UMO actions from the first network node towards the second network node or all the remaining UMO action where the first network node is not involved.
Relating to all the UMO actions from the first network node towards the second network node or all the remaining UMO action where the first network node is not involved, the latter further distinguished per network node (e.g., per third network node). With this information, if the first (or fourth) network node has a signaling connection established towards one or more of the third network nodes, it can understand how the users (or the load) are (is) being shifted beyond the second network node.
Relating to individual UEs, groups of UEs, or UE service types, or 5QIs.
Relating to UEs that were actively handed over from the first network node towards the second network node, or that reconnected to the second network node but could have been served by the first network node (e.g., after a cell at the first network node has been deactivated or reconfigured).
Relating to the UE performance of the UEs

The different disaggregation levels can also be combined in multiple ways. The definition of which disaggregation levels are to be used in the reporting, as well as how to combine them, is either defined in the FIRST MESSAGE or pre-configured. Note that “pre-configured” can refer to something implicitly specified in a 3GPP Technical Specification (or other normative text), or it can refer to configuration parameters being sent in advance (before measurements and/or predictions are collected), e.g., from an OAM/SMO entity (see Section 5 for more details). It can also be that the definition contains different disaggregation levels with different priorities in case that not all disaggregation levels can be supported, the second network node would know which disaggregation level to choose. It can also be that the definition contains conditions for when to use which disaggregation level.

For example, the FIRST MESSAGE could define that the disaggregation (distinction) for measured EC is between a proposed UMO action from the first network node and the measured EC which is independent of this UMO action. Furthermore, the measured EC related to the UMO action should be divided between users with video traffic, users performing voice calls, and other users. Upon measuring a total EC of 50 (in normalized energy cost) units, the second network node could divide this total cost in 20 units due to the UMO action and 30 units which were independent of the UMO action; the cost of the UMO action is further divided in 12 units for the video users, 3 units for the voice users, and 5 units for the other users.

In one embodiment, multiple disaggregation levels can be requested (started, stopped, paused, resumed) for reporting measurements and/or predictions.

In one embodiment, reporting or measurements and/or predictions can be provided according to multiple disaggregation levels.

### 5 Configuring Disaggregation Levels (or Granularity Levels)

The disaggregation levels (or granularity levels) can be configured in advance (i.e., before the measurements and/or predictions are requested). With reference to FIG. 5, the fourth network node can indicate in the FOURTH MESSAGE to one or more of the first/second/third network nodes configuration parameters concerning the disaggregation levels and the cost (e.g., the Energy Cost) associated to an UMO action (or a class of UMO action), as described below.

In one embodiment, the fourth network node sends one or more of the following to one or more of the first, second, and third network nodes:
one or more disaggregation levels, to be used for requesting and reporting measurements and/or predictions related to UMO actions
   different disaggregation levels can be indicated per node
   different disaggregation levels can be indicated per UMO action type
an Energy Cost associated to an UMO action
   in one option, the Energy Cost is the same regardless of UMO action type
   in another option, the Energy Cost is differentiated per UMO action type
an Energy Cost for a certain amount of resources (e.g., PRB) associated to an UMO action
a cost associated to a resource at the network side (other than an Energy cost) for an UMO action. Non-limiting examples can be: a processing cost, a memory consumption cost, a signaling cost
a reference for the Energy Cost, for example the maximum possible Energy Cost for a network node
a reference for the Energy Cost, for example a maximum or a minimum Energy Cost for a UMO action
   in one option, distinct values are used for different types of UMO action

### 6 Implementation Examples

In one example, the FIRST MESSAGE is signaled partly in the (already agreed by RAN3) AI/ML INFORMATION REQUEST message, and partly in the (still discussed) AI/ML ACTION EVALUATION REQUEST message. The SECOND MESSAGE is signaled as part of the AI/ML ACTION EVALUATION RESPONSE message, while the THIRD MESSAGE is signaled as part of the AI/ML INFORMATION UPDATE message. In one example of implementation, the request to provide measurements and/or predictions of certain metrics in a disaggregated manner is realized with an extension of an XnAP message (e.g., an AIML INFORMATION REQUEST message, or similar) as reported below. The parts made bold, italic, and underlined are introduced by this disclosure.

| | | | | | | Assign- |
|---|---|---|---|---|---|---|
| | | | IE type | | | ed |
| | | | and | Semantics | Criti- | Criti- |
| IE/Group Name | Presence | Range | reference | description | cality | cality |
| Message Type | M | | 9.2.3.1 | | YES | reject |
| NG-RAN node1 | M | | INTEGER | Allocated by NG-RAN | YES | reject |
| Measurement ID | | | (1 . . . 4095, . . . ) | node₁ | | |
| (FFS on the name) | | | | | | |
| NG-RAN node2 | C- | | INTEGER | Allocated by NG-RAN | YES | ignore |
| Measurement ID | ifRegistrationRe- | | (1 . . . 4095, . . . ) | node₂ | | |
| (FFS on the name) | questStop | | | | | |
| Registration Request | M | | ENUMERATED(start, | Type of request for | YES | reject |
| | | | stop, . . . ) | which the AI/ML | | |
| | | | (FFS on others) | related information is | | |
| | | | | required. | | |
| Report | C- | | BITSTRING | Each position in the | YES | reject |
| Characteristics | ifRegistrationRe- | | (SIZE(32)) | bitmap indicates the | | |
| | questStart | | | object the NG-RAN | | |
| | | | | node2 is requested to | | |
| | | | | report. | | |
| | | | | First Bit = Predicted | | |
| | | | | Resource Status, | | |
| | | | | Second Bit = | | |
| | | | | Predicted Number of | | |
| | | | | Active UEs, | | |
| | | | | Third Bit = Predicted | | |
| | | | | RRC connections | | |
| | | | | Forth Bit = UE | | |
| | | | | Performance | | |
| | | | | FFS on the coding | | |
| Cell To Report List | | 0 . . . 1 | | Cell ID list to which | YES | ignore |
| | | | | the request applies. | | |
| >Cell To Report Item | | 1 . . . | | | — | |
| | | <maxnoofCellsinNG- | | | | |
| | | RANnode> | | | | |
| >>Cell ID | M | | Global | | — | |
| | | | NG-RAN | | | |
| | | | Cell | | | |
| | | | Identity | | | |
| | | | 9.2.2.27 | | | |
| Reporting Periodicity | O | | ENUMERATED(500 ms, | Periodicity that can | YES | Ignore |
| | | | 1000 ms, | be used for reporting | | |
| | | | 2000 ms, | of requested objects. | | |
| | | | 5000 ms, | Also used as the | | |
| | | | 10000 ms, | averaging window | | |
| | | | . . . ) | length for all objects if | | |
| | | | | supported. | | |
| Reporting | | 0 . . . 1 | | Indicates the | | |
| Granularity | | | | reporting | | |
| | | | | granularity | | |
| | | | | requested to the | | |
| | | | | NG-RAN node2. | | |
| >Reporting Per | | | ENUMERATED | | | |
| Mobility Action | | | (start, | | | |
| | | | stop, . . . ) | | | |
| >Reporting Per 5QI | | | ENUMERATED | | | |
| | | | (start, | | | |
| | | | stop, . . . ) | | | |
| >Reporting per | | | ENUMERATED | | | |
| Energy Saving | | | (start, | | | |
| Action | | | stop, . . . ) | | | |

In one alternative example, there is a unique indication (e.g., a flag) to indicate that a Disaggregated reporting is requested (or enabled, or started, or stopped, or paused, or resumed), and the Disaggregation level is implicit (for instance, the Disaggregation level is “per UMO action”). The Disaggregation level is the same for every prediction and/or measurement requested, see tabular below:

| | | | | | | Assign- |
|---|---|---|---|---|---|---|
| | | | IE type | | | ed |
| | | | and | Semantics | Criti- | Criti- |
| IE/Group Name | Presence | Range | reference | description | cality | cality |
| Message Type | M | | 9.2.3.1 | | YES | reject |
| NG-RAN node1 | M | | INTEGER | Allocated by NG-RAN | YES | reject |
| Measurement ID (FFS | | | (1 . . . 4095, . . . ) | node1 | | |
| on the name) | | | | | | |
| NG-RAN node2 | C- | | INTEGER | Allocated by NG-RAN | YES | ignore |
| Measurement ID (FFS | ifRegistrationRe- | | (1 . . . 4095, . . . ) | node2 | | |
| on the name) | questStop | | | | | |
| Registration Request | M | | ENUMERATED(start, | Type of request for | YES | reject |
| | | | stop, . . . ) | which the AI/ML | | |
| | | | (FFS on | related information is | | |
| | | | others) | required. | | |

(skip unchanged)

| | | |
|---|---|---|
| Disaggregated | O | ENUMERATED |
| Reporting | | (enabled, |
| | | . . . ) |

In a further alternative example, there is an indication for a specific Event, for instance defined as part of the Event Reporting Configuration, to indicate the Disaggregated reporting requested for that specific Event (see tabular below):

### 9.2.3.JJ Event Reporting Configuration

This IE indicates for how long information is to be reported upon event fulfilment:

| | | | IE type and | Semantics | IE/Group | |
|---|---|---|---|---|---|---|
| IE/Group Name | Presence | Range | reference | description | Name | Presence |
| Reporting duration | O | | ENUMERATED | Time duration for | | |
| | | | (0, 1 s, 2 s, | which measurements | | |
| | | | 5 s, 10 s, 20 s, | should be reported | | |
| | | | 60 s, . . . ) | upon fulfilment of the | | |
| | | | | event in seconds. If | | |
| | | | | the value is zero, | | |
| | | | | reporting occurs only | | |
| | | | | once. | | |
| Granularity level | O | | ENUMERATED | Indicates the | | |
| | | | (per- | granularity level | | |
| | | | action, per- | requested for | | |
| | | | UE, per-HO, | reporting AIML | | |
| | | | per-5QI, . . . ) | related information. | | |

In another example of implementation, the measurements and/or predictions are provided in an XnAP message (e.g., an AI/ML ACTION EVALUATION RESPONSE message, or similar) as reported below. The parts made bold, italic and underlined are introduced by this disclosure.

### 9.1.3.ww AI/ML ACTION EVALUATION RESPONSE

This message is sent by NG-RAN node2 to NG-RAN node1 to provide the requested information concerning planned actions

Direction: NG-RAN node2→NG-RAN node1.

| | | | | | | Assign- |
|---|---|---|---|---|---|---|
| | | | | | | ed |
| | | | IE type and | Semantics | Criti- | Criti- |
| IE/Group Name | Presence | Range | reference | description | cality | cality |
| Message Type | M | | 9.2.3.1 | | YES | Ignore |
| Predicted Energy | O | | INTEGER | Value 1 indicates | | |
| Efficiency | | | (0 . . . 100) | the minimum | | |
| | | | | Predicted Energy | | |
| | | | | Efficiency and 100 | | |
| | | | | indicates the | | |
| | | | | maximum | | |
| | | | | Predicted Energy | | |
| | | | | Efficiency. | | |
| | | | | Predicted Energy | | |
| | | | | Efficiency should | | |
| | | | | be measured on a | | |
| | | | | linear scale | | |
| Predicted Energy | O | | INTEGER | Value 1 indicates | | |
| Cost Per Cell | | | (0 . . . 100) | the minimum | | |
| | | | | Predicted Energy | | |
| | | | | Cost and 100 | | |
| | | | | indicates the | | |
| | | | | maximum | | |
| | | | | Predicted Energy | | |
| | | | | Cost. Predicted | | |
| | | | | Energy Cost | | |
| | | | | should be | | |
| | | | | measured on a | | |
| | | | | linear scale. | | |
| Predicted Energy | O | | INTEGER | Value 1 indicates | | |
| Cost Per Handover | | | (0 . . . 100) | the minimum | | |
| | | | | Predicted Energy | | |
| | | | | Cost and 100 | | |
| | | | | indicates the | | |
| | | | | maximum | | |
| | | | | Predicted Energy | | |
| | | | | Cost. Predicted | | |
| | | | | Energy Cost | | |
| | | | | should be | | |
| | | | | measured on a | | |
| | | | | linear scale. | | |

### Example Related to Scenario 6

In Scenario 6, the AI/ML INFORMATION REQUEST may include an IE as follows to instruct the receiving node to report delta metrics relative to the traffic offloaded under such IE:

| | | |
|---|---|---|
| AI-ML Event Information | M | BITSTRING |
| | | (SIZE(128)) |

The same IE above may be included in mobility procedures for which delta metrics want to be achieved. For example, the IE above may be included in all the Handover preparation procedures for which delta metrics want to be received by the second node.

In scenario 6, the AI/ML INFORMATION UPDATE message may be enhanced with the information below:

| | | | | | | |
|---|---|---|---|---|---|---|
| Energy Cost | M | | INTEGER | Value 0 indicates the | | |
| | | | (0 . . . 100) | minimum measured | | |
| | | | | Energy Cost and 100 | | |
| | | | | indicates the maximum | | |
| | | | | measured Energy Cost. | | |
| | | | | Energy Cost should be | | |
| | | | | measured on a linear | | |
| | | | | scale. Energy Cost is | | |
| | | | | measured per node | | |
| Energy Cost per | — | 0 . . . 1 | — | — | YES | ignore |
| Action List | | | | | | |
| >Energy Cost per | — | 1 . . . <maxnoof | — | — | YES | ignore |
| Action Item | | Actions> | | | | |
| >>Energy Cost | M | — | INTEGER | Energy Cost per | — | — |
| | | | (0 . . . 100) | action. Value 0 | | |
| | | | | indicates the | | |
| | | | | minimum measured | | |
| | | | | Energy Cost and 100 | | |
| | | | | indicates the | | |
| | | | | maximum measured | | |
| | | | | Energy Cost. Energy | | |
| | | | | Cost should be | | |
| | | | | measured on a linear | | |
| | | | | scale. | | |
| >>AI-ML Event | M | — | BITSTRING | Indicates the action | — | — |
| Information | | | (SIZE(128)) | for which the Energy | | |
| | | | | Cost is reported. | | |

The information shown is an example of a per node level information (the Energy Cost), which represents the overall Energy Cost for the second network node and that takes into account all traffic factors affecting the second network node.

The Energy Cost Per Action instead, represents the delta metric per offloading actions (UMO action) under the same AI-ML Event Information.

Therefore, the first network node is able to have a measurement of the delta metric (i.e., Energy Cost) consumed for the offloading actions under a given AI-ML Event Information and a measurement for the total per node Energy Cost. The difference between these Energy Cost values is the EC that is independent of any UMO action started by the first network node.

### 7 Further Description

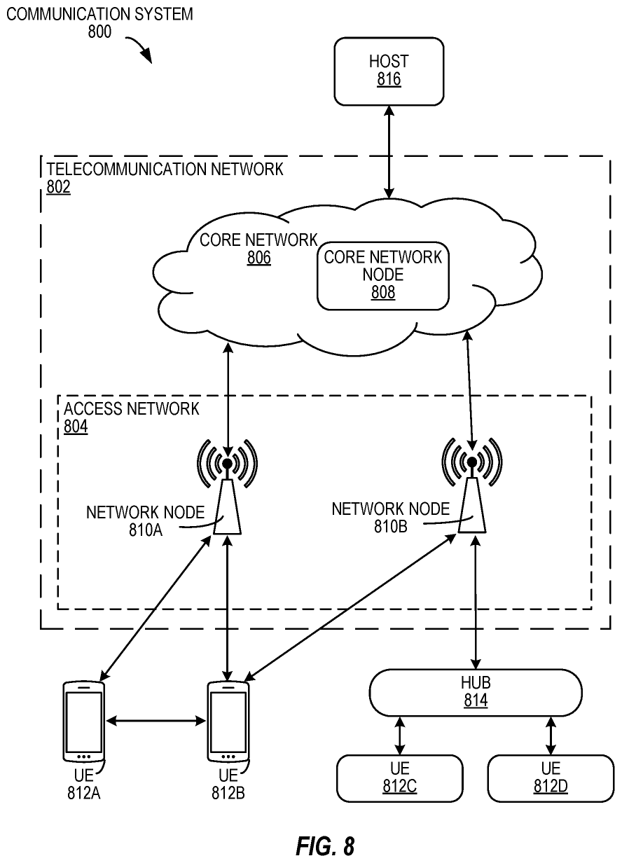

FIG. 8 shows an example of a communication system 800 in accordance with some embodiments.

In the example, the communication system 800 includes a telecommunication network 802 that includes an access network 804, such as a Radio Access Network (RAN), and a core network 806, which includes one or more core network nodes 808. The access network 804 includes one or more access network nodes, such as network nodes 810A and 810B (one or more of which may be generally referred to as network nodes 810), or any other similar Third Generation Partnership Project (3GPP) access nodes or non-3GPP Access Points (APs). Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 802 includes one or more Open-RAN (ORAN) network nodes. An ORAN network node is a node in the telecommunication network 802 that supports an ORAN specification (e.g., a specification published by the O-RAN Alliance, or any similar organization) and may operate alone or together with other nodes to implement one or more functionalities of any node in the telecommunication network 802, including one or more network nodes 810 and/or core network nodes 808.

Examples of an ORAN network node include an Open Radio Unit (O-RU), an Open Distributed Unit (O-DU), an Open Central Unit (O-CU), including an O-CU Control Plane (O-CU-CP) or an O-CU User Plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 810 facilitate direct or indirect connection of User Equipment (UE), such as by connecting UEs 812A, 812B, 812C, and 812D (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system 800 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 802 is a cellular network that implements 3GPP standardized features. Accordingly, the telecommunication network 802 may support network slicing to provide different logical networks to different devices that are connected to the telecommunication network 802. For example, the telecommunication network 802 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-Radio Access Technology (RAT) or multi-standard mode. For example, a UE may operate with any one or combination of WiFi, New Radio (NR), and LTE, i.e. being configured for Multi-Radio Dual Connectivity (MR-DC), such as Evolved UMTS Terrestrial RAN (E-UTRAN) NR-Dual Connectivity (EN-DC).

In the example, a hub 814 communicates with the access network 804 to facilitate indirect communication between one or more UEs (e.g., UE 812C and/or 812D) and network nodes (e.g., network node 810B). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a Virtual Reality (VR) headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular if one or more of the UEs are low energy IoT devices.

The hub 814 may have a constant/persistent or intermittent connection to the network node 810B. The hub 814 may also allow for a different communication scheme and/or schedule between the hub 814 and UEs (e.g., UE 812C and/or 812D), and between the hub 814 and the core network 806. In other examples, the hub 814 is connected to the core network 806 and/or one or more UEs via a wired connection. Moreover, the hub 814 may be configured to connect to a Machine-to-Machine (M2M) service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810B. In other embodiments, the hub 814 may be a non-dedicated hub—that is, a device which is capable of operating to route communications between the UEs and the network node 810B, but which is additionally capable of operating as a communication start and/or end point for certain data channels.

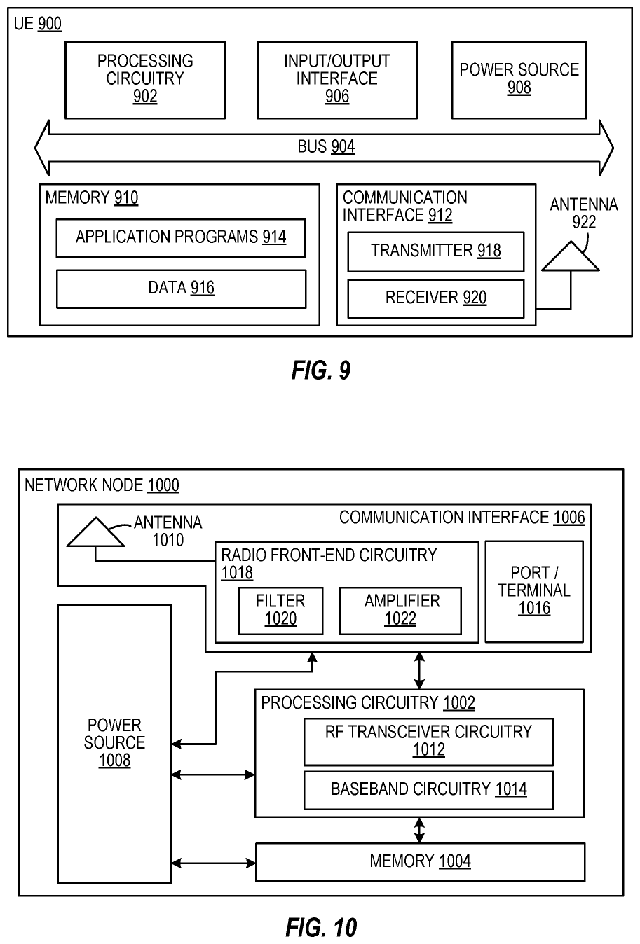

FIG. 9 shows a UE 900 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle, vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 902 may include multiple Central Processing Units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 910 may allow the UE 900 to access instructions, application programs, and the like stored on transitory or non-transitory memory media, to off-load data, or to upload data. An article of manufacture, such as one utilizing a communication system, may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., the antenna 922) and may share circuit components, software, or firmware, or alternatively be implemented separately.

In the illustrated embodiment, communication functions of the communication interface 912 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 10 shows a network node 1000 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), NR Node Bs (gNBs)), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node), and/or Remote Radio Units (RRUs), sometimes referred to as Remote Radio Heads (RRHs). Such RRUs may or may not be integrated with an antenna as an antenna integrated radio. Parts of a distributed radio base station may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes processing circuitry 1002, memory 1004, a communication interface 1006, and a power source 1008. The network node 1000 may be composed of multiple physically separate components (e.g., a NodeB component and an RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, the network node 1000 may be configured to support multiple RATs. In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1000.

The processing circuitry 1002 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1000 components, such as the memory 1004, to provide network node 1000 functionality.

In some embodiments, the processing circuitry 1002 includes a System on a Chip (SOC). In some embodiments, the processing circuitry 1002 includes one or more of Radio Frequency (RF) transceiver circuitry 1012 and baseband processing circuitry 1014. In some embodiments, the RF transceiver circuitry 1012 and the baseband processing circuitry 1014 may be on separate chips (or sets of chips), boards, or units, such as radio units and digital units. In alternative embodiments, part or all of the RF transceiver circuitry 1012 and the baseband processing circuitry 1014 may be on the same chip or set of chips, boards, or units.

The memory 1004 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and the memory 1004 are integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. The radio front-end circuitry 1018 comprises filters 1020 and amplifiers 1022. The radio front-end circuitry 1018 may be connected to the antenna 1010 and the processing circuitry 1002. The radio front-end circuitry 1018 may be configured to condition signals communicated between the antenna 1010 and the processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of the filters 1020 and/or the amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface 1006 may comprise different components and/or different combinations of components.

In certain alternative embodiments, the network node 1000 does not include separate radio front-end circuitry 1018; instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes the one or more ports or terminals 1016, the radio front-end circuitry 1018, and the RF transceiver circuitry 1012 as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, the communication interface 1006, and/or the processing circuitry 1002 may be configured to perform any receiving operations and/or certain obtaining operations described herein as being performed by the network node 1000. Any information, data, and/or signals may be received from a UE, another network node, and/or any other network equipment. Similarly, the antenna 1010, the communication interface 1006, and/or the processing circuitry 1002 may be configured to perform any transmitting operations described herein as being performed by the network node 1000. Any information, data, and/or signals may be transmitted to a UE, another network node, and/or any other network equipment.

The power source 1008 provides power to the various components of the network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid or an electricity outlet) via input circuitry or an interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

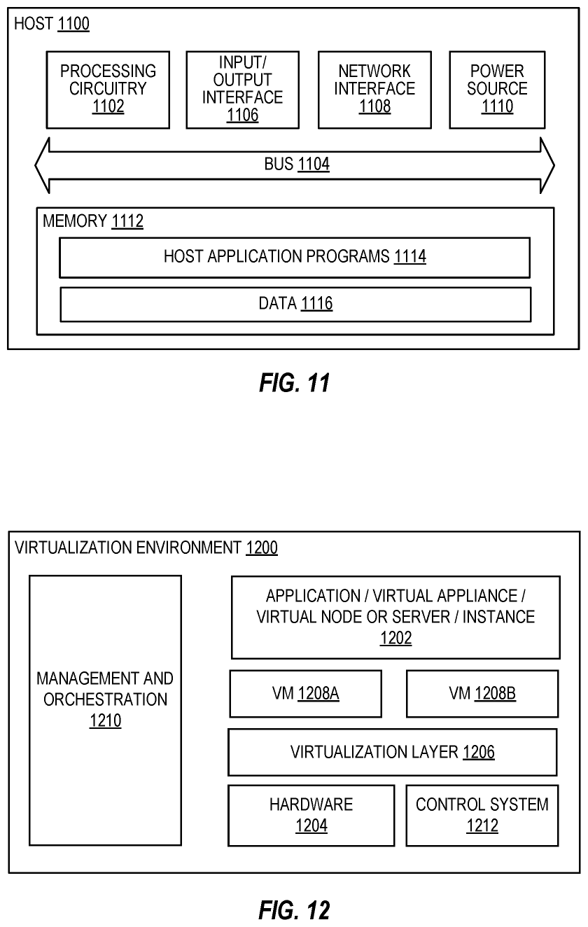

FIG. 11 is a block diagram of a host 1100, which may be an embodiment of the host 816 of FIG. 8, in accordance with various aspects described herein. As used herein, the host 1100 may be or comprise various combinations of hardware and/or software including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and memory 1112. Other components may be included in other embodiments. Features of these components may be substantially similar to those described with respect to the devices of previous figures, such as FIGS. 9 and 10, such that the descriptions thereof are generally applicable to the corresponding components of the host 1100.

The memory 1112 may include one or more computer programs including one or more host application programs 1114 and data 1116, which may include user data, e.g. data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for Over-The-Top (OTT) services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1200 includes components defined by the O-RAN Alliance, such as an O-Cloud environment orchestrated by a Service Management and Orchestration Framework via an O-2 interface.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or VM Monitors (VMMs)), provide VMs 1208A and 1208B (one or more of which may be generally referred to as VMs 1208), and/or perform any of the functions, features, and/or benefits described in relation with some embodiments described herein. The virtualization layer 1206 may present a virtual operating platform that appears like networking hardware to the VMs 1208.

The VMs 1208 comprise virtual processing, virtual memory, virtual networking, or interface and virtual storage, and may be run by a corresponding virtualization layer 1206. Different embodiments of the instance of a virtual appliance 1202 may be implemented on one or more of the VMs 1208, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1208 may be a software implementation of a physical machine that runs programs as if they were executing on a physical, non-virtualized machine. Each of the VMs 1208, and that part of the hardware 1204 that executes that VM, be it hardware dedicated to that VM and/or hardware shared by that VM with others of the VMs 1208, forms separate virtual network elements. Still in the context of NFV, a virtual network function is responsible for handling specific network functions that run in one or more VMs 1208 on top of the hardware 1204 and corresponds to the application 1202.

The hardware 1204 may be implemented in a standalone network node with generic or specific components. The hardware 1204 may implement some functions via virtualization. Alternatively, the hardware 1204 may be part of a larger cluster of hardware (e.g., such as in a data center or CPE) where many hardware nodes work together and are managed via management and orchestration 1210, which, among others, oversees lifecycle management of the applications 1202. In some embodiments, the hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a base station. In some embodiments, some signaling can be provided with the use of a control system 1212 which may alternatively be used for communication between hardware nodes and radio units.

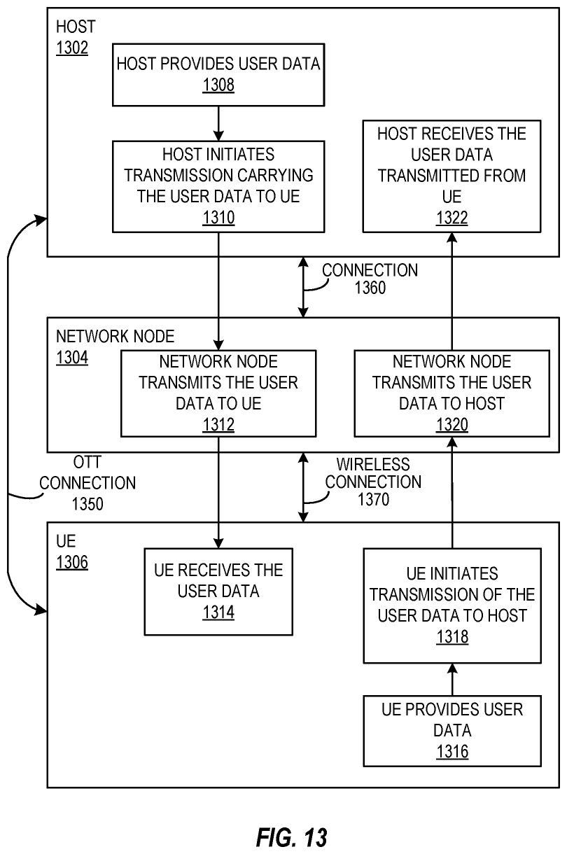

FIG. 13 shows a communication diagram of a host 1302 communicating via a network node 1304 with a UE 1306 over a partially wireless connection in accordance with some embodiments. Example implementations, in accordance with various embodiments, of the UE (such as the UE 812A of FIG. 8 and/or the UE 900 of FIG. 9), the network node (such as the network node 810A of FIG. 8 and/or the network node 1000 of FIG. 10), and the host (such as the host 816 of FIG. 8 and/or the host 1100 of FIG. 11) discussed in the preceding paragraphs will now be described with reference to FIG. 13.

Like the host 1100, embodiments of the host 1302 include hardware, such as a communication interface, processing circuitry, and memory. The host 1302 also includes software, which is stored in or is accessible by the host 1302 and executable by the processing circuitry. The software includes a host application that may be operable to provide a service to a remote user, such as the UE 1306 connecting via an OTT connection 1350 extending between the UE 1306 and the host 1302. In providing the service to the remote user, a host application may provide user data which is transmitted using the OTT connection 1350.

The network node 1304 includes hardware enabling it to communicate with the host 1302 and the UE 1306. The connection 1360 may be direct or pass through a core network (like the core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by the UE 1306 and executable by the UE's processing circuitry. The software includes a client application, such as a web browser or operator-specific “app” that may be operable to provide a service to a human or non-human user via the UE 1306 with the support of the host 1302. In the host 1302, an executing host application may communicate with the executing client application via the OTT connection 1350 terminating at the UE 1306 and the host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via the connection 1360 between the host 1302 and the network node 1304 and via a wireless connection 1370 between the network node 1304 and the UE 1306 to provide the connection between the host 1302 and the UE 1306. The connection 1360 and the wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304 in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR, or AR which it can broadcast, multicast, or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1350 between the host 1302 and the UE 1306 in response to variations in the measurement results. The measurement procedure and/or the network functionality for reconfiguring the OTT connection 1350 may be implemented in software and hardware of the host 1302 and/or the UE 1306. In some embodiments, sensors (not shown) may be deployed in or in association with other devices through which the OTT connection 1350 passes; the sensors may participate in the measurement procedure by supplying values of the monitored quantities exemplified above, or by supplying values of other physical quantities from which software may compute or estimate the monitored quantities. The reconfiguring of the OTT connection 1350 may include message format, retransmission settings, preferred routing, etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency, and the like by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Those skilled in the art will recognize improvements and modifications to the embodiments of the present disclosure. All such improvements and modifications are considered within the scope of the concepts disclosed herein.

1. A method performed by a second network node, the method comprising:
receiving one or more first messages from either a first network node or a fourth network node, wherein the one or more first messages comprises one or more requests for reporting either or both of: (a) one or more predictions of one or more certain metrics in relation to one or more User Equipment (UE), mobility and offloading (UMO) actions that involve at least the second network node and the first network node and/or a third network node and (b) one or more measurements of the one or more certain metrics in relation to the one or more UMO actions that involve at least the second network node and the first network node and/or the third network node; and
either or both of:
transmitting a second message to either the first network node or the fourth network node, wherein the second message comprises the one or more predictions of the one or more certain metrics in a disaggregated manner such that, the one or more predictions of the one or more certain metrics reflect separate contributions of the one or more UMO actions;
transmitting a third message to either the first network node or the fourth network node, wherein the third message comprises the one or more measurements of the one or more certain metrics in a disaggregated manner such that, the one or more measurements of the one or more certain metrics reflect separate contributions of the one or more UMO actions.

2. The method of claim 1, wherein the one or more requests comprises a request for reporting the one or more predictions of the one or more certain metrics in relation to the one or more UMO actions that involve at least the second network node, and the method comprises:
deriving the one or more predictions of the one or more certain metrics in relation to the one or more UMO actions that involve at least the second network node; and
transmitting the second message to either the first network node or the fourth network node, wherein the second message comprises the one or more predictions of the one or more certain metrics in relation to the one or more UMO actions in the disaggregated manner.

3. The method of claim 1, wherein the one or more requests comprises a request for reporting the one or more measurements of the one or more certain metrics in relation to the one or more UMO actions that involve at least the second network node, and the method comprises:
receiving at least a UE and/or a certain load from the first network node in relation to the one or more UMO actions;
deriving the one or more measurements of the one or more certain metrics in relation to the one or more UMO actions that involve at least the second network node, based on the at least the UE and/or the certain load received from the first network node; and
transmitting the third message to either the first network node or the fourth network node, wherein the third message comprises the one or more measurements of the one or more certain metrics in relation to the one or more UMO actions in the disaggregated manner.

4. The method of claim 1, wherein the one or more requests indicate, explicitly or implicitly, a granularity of at least one disaggregation level to be used for the one or more predictions and/or the one or more measurements comprised in the second message and/or third message.

5. The method of claim 1, wherein the reported predictions and/or measurements further comprise one or more values that reflect a contribution that is independent of any UMO action in the one or more certain metrics.

6. The method of claim 1, wherein each UMO action of the one or more UMO actions is an action or set of actions where at least a UE and/or a certain load is transferred from the first network node to the second network node or between the second network node and one or more third network nodes.

7. The method of claim 6, where at least one of the one or more UMO actions is a handover of one or more UEs.

8. The method of claim 6, where at least one of the one or more UMO actions is an addition, modification, or release of a secondary cell or secondary cell group.

9. The method of claim 6, where each UMO action may be any one of the following:
a handover of one or more UEs;
a future extension of L1/L2 Triggered Mobility (LTM) of one or more UEs for inter-node mobility;
a Radio Resource Control (RRC), release of one or more UEs;
a configuration of cell reselection priorities of one or more UEs;
an RRC release with redirection of one or more UEs;
a configuration of redirected carrier info for one or more UEs;
an RRC reconfiguration of one or more UEs;
a modification of broadcasted and/or on-demand provided system information influencing all UEs' cell selection and reselection process;
a cell deactivation or activation;
Synchronization Signal Block (SSB) beam deactivation or activation;
modification of a downlink output power (e.g., for downlink to one or more UEs);
modification of an antenna tilt;
modification of a mobility/handover trigger setting.

10. The method of claim 1, wherein at least one of the one or more first messages further comprises information that defines or indicates the one or more UMO actions.

11. The method of claim 1, wherein the one or more certain metrics comprise energy consumption or cost and/or resource utilization.

12-13. (canceled)

14. A second network node comprising:
a communication interface; and
processing circuitry associated with the communication interface, the processing circuitry configured to cause the second network node to:
receive one or more first messages from either a first network node or a fourth network node, wherein the one or more first messages comprises one or more requests for reporting either or both of: (a) one or more predictions of one or more certain metrics in relation to one or more User Equipment (UE); mobility and offloading (UMO) actions that involve at least the second network node and the first network node and/or a third network node and (b) one or more measurements of the one or more certain metrics in relation to the one or more UMO actions that involve at least the second network node and the first network node and/or the third network node; and
either or both of:
transmit a second message to either the first network node or the fourth network node, wherein the second message comprises the one or more predictions of the one or more certain metrics in a disaggregated manner such that, the one or more predictions of the one or more certain metrics reflect separate contributions of the one or more UMO actions;
transmit a third message to either the first network node or the fourth network node, wherein the third message comprises the one or more measurements of the one or more certain metrics in a disaggregated manner such that, the one or more measurements of the one or more certain metrics reflect separate contributions of the one or more UMO actions.

15. (canceled)

16. A method performed by a first network node, the method comprising:
sending one or more first messages to a second network node, wherein the one or more first messages comprises one or more requests for reporting either or both of: (a) one or more predictions of one or more certain metrics in relation to one or more User Equipment (UE) mobility and offloading (UMO), actions that involve at least the second network node and the first network node and/or a third network node and (b) one or more measurements of the one or more certain metrics in relation to the one or more UMO actions that involve at least the second network node and the first network node and/or the third network node; and
either or both of:
receiving a second message from the second network node, wherein the second message comprises the one or more predictions of the one or more certain metrics in a disaggregated manner such that, the one or more predictions of the one or more certain metrics reflect separate contributions of the one or more UMO actions;
receiving a third message from the second network node, wherein the third message comprises the one or more measurements of the one or more certain metrics in a disaggregated manner such that, the one or more measurements of the one or more certain metrics reflect separate contributions of the one or more UMO actions.

17. The method of claim 16, wherein the one or more requests comprises a request for reporting the one or more predictions of the one or more certain metrics in relation to the one or more UMO actions that involve at least the second network node, and the method comprises:
receiving the second message from the second network node, wherein the second message comprises the one or more predictions of the one or more certain metrics in relation to the one or more UMO actions in the disaggregated manner.

18. The method of claim 17, further comprising implementing one or more system changes that result in at least one of the one or more UMO actions (e.g., based on the one or more predictions).

19. The method of claim 16, wherein the one or more requests comprises a request for reporting the one or more measurements of the one or more certain metrics in relation to the one or more UMO actions that involve at least the second network node, and the method comprises:
receiving the third message from the first network node, wherein the third message comprises the one or more measurements of the one or more certain metrics in relation to the one or more UMO actions in the disaggregated manner.

20. The method of claim 16, wherein the one or more requests indicate, explicitly or implicitly, a granularity of at least one disaggregation level to be used for the one or more predictions and/or the one or more measurements comprised in the second message and/or third message.

21. The method of claim 16, wherein the reported predictions and/or measurements further comprise one or more values that reflect a contribution that is independent of any UMO action in the one or more certain metrics.

22. The method of claim 16, wherein each UMO action of the one or more UMO actions is an action or set of actions where at least a UE and/or a certain load is transferred from the first network node to the second network node or between the second network node and one or more third network nodes.

23-29. (canceled)

30. A first network node comprising:
a communication interface; and
processing circuitry associated with the communication interface, the processing circuitry configured to cause the first network node to:
send one or more first messages to a second network node, wherein the one or more first messages comprises one or more requests for reporting either or both of: (a) one or more predictions of one or more certain metrics in relation to one or more User Equipment (UE) mobility and offloading (UMO) actions that involve at least the second network node and the first network node and/or a third network node and (b) one or more measurements of the one or more certain metrics in relation to the one or more UMO actions that involve at least the second network node and the first network node and/or the third network node;
either or both of:
receiving a second message from the second network node, wherein the second message comprises the one or more predictions of the one or more certain metrics in a disaggregated manner such that, the one or more predictions of the one or more certain metrics reflect separate contributions of the one or more UMO actions;
receiving a third message from the second network node, wherein the third message comprises the one or more measurements of the one or more certain metrics in a disaggregated manner such that, the one or more measurements of the one or more certain metrics reflect separate contributions of the one or more UMO actions.

31-48. (canceled)
